(19) United States
(12) Patent Application Publication
(10) Pub. No.: US 2013/0067115 A1
(43) Pub. Date: Mar. 14, 2013

(54) Method And System For Mapping Domain Prefixes To Qualified URLs

(71) Applicant: Isaac Omar Lapanc, Fullerton, CA (US)

(72) Inventor: Isaac Omar Lapanc, Fullerton, CA (US)

(21) Appl. No.: 13/612,818

(22) Filed: Sep. 12, 2012

Related U.S. Application Data
(60) Provisional application No. 61/533,271, filed on Sep. 12, 2011.

(51) Int. Cl. G06F 15/16

(52) U.S. Cl. 709/245

(57) ABSTRACT

A centralized host server domain can be setup to process all the A (Address) wildcard DNS records of matching non-existent domain names. The left-most label of the non-existent domain will be identified as the “DOMAIN PREFIX” and it will be extracted from the non-existent domain name of the Universal Resource Locator (URL) HTTP Request that is sent by a client. The host server will use the extracted “DOMAIN PREFIX” and perform a search against a centralized database where Domains' output URLs are defined and mapped to “DOMAIN PREFIX” values. The search result, which can be a single URL or multiple URLs, of the same or different protocol, will be sent back to the client as the Response. Domain Prefixes values and their associated keywords that are stored in the centralized database and mapped to output URLs will be accessed and utilized by new and existing internet resources search engines.

### CROSS-REFERENCES TO RELATED APPLICATIONS

The present application claims priority from U.S. Provisional Application Ser. No. 61/533,271 filed on Sep. 12, 2011, which is hereby incorporated herein by reference in its entirety.

### TECHNICAL FIELD

The A (Address) wildcard DNS record is a record in a DNS zone that will match requests for non-existent domain names. This invention relates generally to methods of accessing internet resources using URLs (Universal Resource Locators). In specific, it relates to a noble method of utilizing the non-existent domain names and uses the left-most label, identified as the “DOMAIN PREFIX”, for the purpose of managing output URLs that are specific to each domain. The invention makes it easy to map long and complex URLs to a more user friendly, meaningful, and descriptive non-existent domain name. The defined “DOMAIN PREFIX” values along with their associated keywords and re-direct output URLs will be stored in a centralized database to be accessed and utilized for the purpose of locating specific internet resources of the same or different protocol.

### BACKGROUND OF THE INVENTION

Requests and Responses are the methods of obtaining internet resources. The request is initiated by the client, normally by entering a URL address into a web browser or by a software application that generates the URL to be sent as a Request. Upon initiating a Request, the host server that will be receiving the requests, which stores contents such as HTML and other files, or processes various functions on behalf of the client, will return responses in the form of messages to the client.

The Response message that is sent back to the client by the host server can contain a task completion status about the Request that was initiated by the client or a content of a resource presented in HTML (Hyper Text Markup Language), which is the predominant language in building web pages' contents that can be rendered to the client. Generally, to be displayed on the client's browser

The Request-Response computing model, which is technically known as the client-server computing model, is made available through the Hypertext Transfer Protocol (HTTP) which is designed to permit intermediate network elements to improve and enable communications between the clients and the servers.

Transmission Control Protocol/Internet Protocol (TCP/IP) is the networking protocol that ensures the unique identity of host servers on the internet. Each host server machine needs to be assigned a unique IP address. This protocol ensures that all qualified domain names are pointing to a unique host server machine.

The rules of forming a domain name are specified by the Internet Network Information Center which is known as InterNIC, articles RFC 1035, RFC 1123, and RFC 2181. The rules indicates that the characters a through z, A through Z, digits 0 through 9, and the hyphen “-” are the only characters that are allowed and the domain name can not start or end with the hyphen “-”. This rule is known as the LDH rule (letters, digits, hyphen). The domain name consists of one or more parts which are called labels. These labels are concatenated and delimited by dots “.”, such as MyBrandedName.com. The right-most label is known as the top-level domain (TLD). For example, the domain name MyBrandedName.com consists of MyBrandedName as the domain and com as the top level domain.

Once the domain name is registered, the website design is established by either the owner of the domain himself/herself or it is handed to a web design firm. Upon completion, the website is then deployed to a host server machine that is connected to the internet and identified by a unique IP address

Branding is the concept of obtaining an internet identity (DOMAIN NAME). It involves registering a domain name through a domain name registrar organization such as godaddy.com, networksolutions.com, and verio.com to name a few. It is always desired to obtain a domain name that reflects the service or the product being offered by the one seeking the domain name, which may or may not be available. Since the cost of registering a domain name has dropped significantly, it has been common for someone to register massive number of domains for the sake of auctioning them in the future. The contact information, such as the name, phone number, company name (optional), and address are required by ICANN (Internet Corporation for assigned Names and Numbers) when registering a domain. The contact information can be public or private. Domain tools, such as whois.domaintools.com, provide a way to get the contact information for given domain if it is set to be public.

Another means of establishing an internet presence is by subscribing to popular domains, for example: ebay.com, facebook.com, and twitter.com. Where the URL address of the web page will take on the format of PopularDomain.comkRegistered-Name-WEB-PAGE> where the obtained <Registered-Name-WEB-PAGE> is unique to the hosting domain and subject to availability and it is obtained on a first come first served basis. It is a common practice for popular domains to require the user to enter contact information such as the name, phone number, and address.

Domain resources are accessed by Uniform Resource Locator (URL). Every URL consists of some of the following:

The scheme name (the protocol), followed by a colon “:”, then, depending on the scheme, a domain name, a port number, and the path of the resource

### SCHEME://DOMAIN:PORT/<PATH>

Some of the most commonly used protocols are:
1. Hypertext Transfer Protocol (HTTP)
2. File Transfer Protocol (FTP)
3. Simple Mail Transfer Protocol (SMTP)

The Hypertext Transfer Protocol (HTTP) takes on the following format: HTTP://<HOST NAME>[:PORT #][/ABSOLUTE PATH][?<QUERY STRING>][#<FRAGMENT>] (The bracketed parts are optional) The <HOST NAME> is mandatory and should be the qualified domain name or the IP address. For example, http://MyBrandedName.com will render the default page, as defined on the host machine's web server engine, to the browser which can be http://MyBrandedName.com/Default.aspx

The File Transfer Protocol (FTP) is a standard network protocol used to transfer files from one host machine to another over TCP-based network, such as the internet.

FTP URL syntax is described in RFC1738 and it takes on the following form:
FTP://[<USER>[:<PASSWORD>]@]<HOST>[:<PORT>]/<URL-PATH> (The bracketed parts are optional) For example: ftp://ftp.uspto.gov/pub/forms/ProvisionalSB.pdf

The Simple Mail Transfer Protocol (SMTP) is an internet standard for electronic mail (e-mail) transmission across the Internet Protocol (IP) networks.

The mailto URI scheme, as registered with the Internet Assigned Numbers Authority (IANA), defines the scheme for Simple Mail Transfer Protocol (SMTP) email addresses. Its format is defined as:

### <MAILTO>:<EMAIL ADDRESS>@<DOMAIN>

For example, mailto:emailaddress @MyBrandedName.com

Typing the above URL into a web browser or clicking on the link when embedded within an HTML document in the following form:

<a href=“mailto:emailaddress @MyBrandedName.com”>Send Mail<a>, will open a new message window of the user's client default email application program, such as Microsoft Office Outlook running on a desktop, with the email address emailaddress@MyBrandedName.com defined by the URL in the “To:” field. This is also generally the case in most smart devices and phones such as the popular IPHONE, BLACKBERRY, IPAD, and numerous other smart devices' manufacturers.

An application programming interface (API) is a particular set of rules (‘code’) and specifications that software programs can follow to communicate with each other. It serves as an interface between different software programs and facilitates their interaction, similar to the way the user interface facilitates interaction between humans and computers. An API can be created for applications, libraries, operating systems, etc., as a way of defining their “vocabularies” and resources request conventions (example: function-calling conventions). It may include specifications for routines, data structures, object classes, and protocols used to communicate between the consumer program and the implementer program of the API.

A Web service is a method of communication between two electronic devices over a network. Web Services were intended to solve three main problems, that is Firewall Traversal, Complexity, and Interoperability.

Web API is a development in Web applications. Web APIs allow the combination of multiple Web services into new applications. When used in the context of Web development, Web API is typically a defined set of Hypertext Transfer Protocol (HTTP) request messages along with a definition of the structure of response messages, usually expressed in an Extensible Markup Language (XML) or JavaScript Object Notation (JSON) format.

Web crawling is used by major search engines, for example: GOOGLE.COM, BING.COM, and YAHOO.COM. It is the process of scanning the content of web pages for later processing by the search engine that will index the visited pages to provide the user's search request on the search engine's main website. It analyzes and indexes the visited pages.

In computing, a user agent is a client application implementing a network protocol used in communications within a client-server distributed computing system. Web user agents range from Web browsers to search engine crawlers (spiders), as well as mobile phones, screen readers and Braille browsers used by people with disabilities. When a user agent operates, it typically identifies itself, its application type, operating system, software vendor, or software revision, by submitting a characteristic identification string to its operating peer. In the HTTP, SIP, and SMTP/NNTP protocols, this is transmitted in a header field User-Agent. Bots, such as Web crawlers, often also include a URL and/or e-mail address so that the Webmaster can contact the operator of the bot.

A relational database management system (RDBMS) is a database management system (DBMS) that is based on the relational model. Most popular commercial and open source databases currently in use are based on the relational database model. It is a collection of tables for storing information in a restricted manner maintaining the integrity of the information and their relationship.

Regular expression, also referred to as REGEX or REGEXP, provides a concise and flexible means for matching strings of text, such as particular characters, words, or patterns of characters. A regular expression is written in a formal language that can be interpreted by a regular expression processor, a program that either serves as a parser generator or examines text and identifies parts that match the provided specification.

Accessing the internet is made available through Landline and wireless networks such as the 3G and 4G wireless networks

Internet carriers provide several internet access usage plans, known to be data plans. Pricing is also determined by the options. Examples, unlimited data plan versus limited amount of usage in which if it is exceeded, an over usage charge will be applied.

The Internet maintains two principal namespaces, the domain name hierarchy and the Internet Protocol (IP) address system. The Domain Name System maintains the domain namespace and provides translation services between these two namespaces. Internet name servers and a communication protocol implement the Domain Name System. A DNS name server is a server that stores the DNS records for a domain name, such as address (A) records, name server (NS) records, and mail exchanger (MX) records; a DNS name server responds with answers to queries against its database.

In general, the Domain Name System also stores other types of information, such as the list of mail servers that accept email for a given Internet domain. By providing a worldwide, distributed keyword-based redirection service, the Domain Name System is an essential component of the functionality of the Internet.

Domain Name System (DNS) translates IP addresses to their associated human qualified domain names. For example, after pointing MyBrandedName.com to the host server's IP address 152.25.26.34, the user needs not to remember the IP address and instead can use the domain name MyBrandedName.com to access the internet resource, which in this case, is the main website

Domain name registrar organizations provide a Domain Name System (DNS) management tool for setting up host records which is known as “DNS manager”. The tool provides the mean to edit the Zone file of the domain. The Zone file is a text file that describes a DNS zone and contains mapping between domain names and host servers' IP addresses and other resources. The A(Address) host records are mapped to IP addresses and the CNAME(Alias) records are mapped to qualified domains or one of the domain's defined A(Address) host records. The combined list of records within the zone file must be unique. The Domain Name System (DNS) zone file does not permit the use of fully qualified URLs. For example, it is not permitted to setup the CNAME (Alias) host record “contact” to point to MyBrandedName.com/contact.aspx. A wild card DNS record is permitted to be setup as an A (Address) host record. When a wild card record is present in a zone file of a domain, all the non-existing sub domains will be directed to the assigned host server's IP address. When a non-existing domain reaches the assigned host server, the default web site that is setup on the host server will be rendered to the client that originated the Request. Records within the zone file can point to the same or different host server IP address. Once an A (Address) host record of a domain is setup to point to an IP address, it is then considered to be a qualified domain, also known as a sub domain.

Table-1 illustrates the use of the DNS Manager tool to setup the A (Address) host records of the domain MyBrandedName.com

TABLE 1
MyBrandedName.com list of A (Address) host records

| Entry # | Host | Points to IP address |
|---|---|---|
| 1 | @ | 24.199.12.218 |
| 2 | Subdomain1 | 24.199.12.218 |
| 3 | suLable1.subLabel2 | 106.123.16.213 |
| 4 | * | 24.199.12.218 |

Entry #1: Resolves the qualified domain MyBrandedName.com to point to the host server 24.199.12.218

Entry #2: A single label qualified domain, known as a sub domain; subdomain1.MyBrandedName.com that will point to the same host server of the main domain MyBrandedName.com it can also be setup to point to a different host server

Entry #3: A multiple labels qualified domain, known as a sub domain and it consists of 2 labels; subLabel1.subLabel2.MyBrandedName.com that points to a different host server than the main domain name MyBrandedName.com

Entry #4: A wild card record setting that will direct all the non-existing domains to the default website that is setup on the host server 24.199.12.218 machine. Examples of non-existent domain names: anythingOtherThanDnsRecords.MyBrandedName.com

Table-2 illustrates the use of a DNS Manager tool to setup the CNAME (Alias) host records for the domain MyBrandedName.com

TABLE 2
MyBrandedName.com list of CNAME (Alias) records

| | | Points to A(Address) host record |
|---|---|---|
| | | or a qualified domain in the form |
| Entry # | Host | of subdmain.domain.tld |
| 5 | ftp | ftp.anotherFtpServer.com |
| 6 | WWW | @ |
| 7 | 6192990606 | @ |
| 8 | Search | Google.com |
| 9 | Value1.value2 | @ |
| 10 | Smtp | Smpt.anotherMailSever.com |
| 11 | * | Urlisp.com |

Entry #5: Resolves the domain ftp.MyBrandedName.com to ftp.anotherFtpServer.com

Entry #6: Resolves the domain www.MyBrandedName.com to the host server 24.199.12.218

Entry #7: Resolves the qualified domain 6192990668.MyBrandedName.com to the host server 24.199.12.218 which is the same as MyBrandedName.com

Entry #8: Resolves the qualified domain search.MyBrandedName.com to google.com

Entry #9: Resolves the qualified domain value1.value2.MyBrandedName.com to MyBrandedName.com, which in terms is setup to point to the host server 24.199.12.218

Entry #10: Resolves the smtp.MyBrandedName.com to smtp.anotherMailserver.com

Entry #11: A wild card record setting that will direct all the non-existing domains to the default website that is setup on the host server machine of the domain urlisp.com. This option is not available through all ISP providers. However, it is relevant to the invention to mention that this setting can be used instead of the Entry#4 in Table-1 when it is available for a DNS Manager tool of an ISP provider. An example of an ISP provider that makes this option available is NetworkSolutions.com and an example of an ISP provider that does not offer it is Godaddy.com. However, both ISP providers allow for the setup of an A(Record) wild card as mentioned in Entry#4 in Table-1

If the user tries to setup an entry in Table-2 to point to a fully qualified URL address, for example: if the user tries to setup the entry “test” to point to somedomain.com/somepage.aspx, the user will be prompted with an error message indicating that a CNAME (Alias) record must point to a domain in the form of subdomain.domain.tld or a valid A (Host) record that is setup for the domain

The host servers that are being assigned in Table-1 and identified by their IP addresses must also perform some settings on the web server's engine before the URLs are resolved. For example: some of the major settings are:
1. Set the local path directory for the domain's website
2. Create a new website to host MyBrandedName.com
3. Set the host header name for the domain host MyBrandedName.com that is being hosted, this setting will resolve the Table-1—Entry #1 A(address) host record
4. Setup Host header Records to handle all A(Address) host records that are setup as sub domains. For example: subdomain1.MyBrandedName.com as in the Table-1—Entry #2 A(address) host record

The internet resources of a Domain are generally a collection of files residing on the host server's hard drive within a designated root folder known as the hosted website's directory. Host servers typically host multiple domains where the resources of each domain are contained in a separate root folder.

Content of the pages that are rendered by the host server's web rendering engine are known as web pages. These contents can be static, for example:
1) MyBrandedName.com/contact.htm where the resource contact.htm is a single file that is located in the root folder
2) MyBrandedName.com/gallery/galleryPage.htm where the resource galleryPage.htm is a single file that is residing in the sub folder “/gallery” off the root folder.

Content of the web pages can also be dynamic, and are rendered by the hosting web server's engine based on one or more key/value pairs in the query string part of the Http's protocol URL. For example: MyBrandedName.com/search.aspx?product=cars where the resource file search.aspx is a single file residing in the root folder but the content of the page is dynamically generated based on the key/value pair “product=cars” that is present to the right of “?” symbol

The dynamically generated contents are the most commonly used format and are generally very long and virtually impossible to remember. Dynamic pages are normally generated and accessed in response to a certain input or choice that is provided by the user. For example, when typing a physical address in the maps.google.com web page, the host server will response by rendering a page which will have a URL similar to the following:

http://maps.google.com/maps?f=q&source=s_q&h1=en&geocode=&q=351+West+University+Avenue,+San+Diego,+CA&aq=1&s11=37.0625,-95.677068&sspn=64.281297,111.269531&ie=UTF8&hq=&hnear=351+W+University+Ave,+San+Diego,+California+92103&z=17&iwloc=A

Dynamically generated web contents are also commonly used in major websites such as amazon.com, ebay.com where the URL is generated in response to the user clicking on menu options while navigating the website. For example, the following URL is generated once the user clicks on the “Kindle->Kindle DX” menu option off the main amazon.com website, the amazon.com host server will response by rendering a page with the following URL

http://www.amazon.com/Kindle-Wireless-Reading-Display-Generation/dp/B002GYWHSQ/ref=sa_menu_kdx23

It is very common for an establishment to include its phone number on the titles, footer, and as a part of the contact page. The phone number has been and still is a primary contact mean to a lot of businesses and individuals alike. It is published in phone books, business cards, flyers and all other means of advertisements. Phone numbers are globally unique by country code, area code and local number. In most cases, they are established and published prior to obtaining any internet presence. However, there is no way to associate the phone number to its internet resources such as the website, email address, or other internet URL links that are established with other domains. This is mainly due to the existing DNS current established rules of setting up the A (Address) and CNAME (Alias) host records. It is advantageous to be able to associate resources including URLs of individuals, institutions, organizations, and so forth to an existing unique defined entity such as the phone number. For example: it would be advantageous to have a service domain such as urlisp.com that can serve as the world wide extension of all phone numbers in the form of phoneNumber.urlisp.com that associates all the related internet resources of the owner of the phone number. Once the phoneNumber.urlisp.com domain is requested, typically by entering the URL http://phoneNumber.urlisp.com into a web browser, the list of all the defined associated resources can then be rendered by the hosting server as a response. Moreover, once the phone number is registered with the domain urlisp.com, it can then be used and associated with other domains making it possible to type the URL http://phoneNumber.maps.google.com or http://map.phoneNumber.urlisp.com to re-direct right to the map page without having to type the physical address or remember the very long URL.

Currently there is the need for a flexible, cost effective and global solution to the following problems that are associated to URLs:
1) The ability to present fully qualified URLs as a part of the qualified domain name, especially the URLs that are long and very complex, and have it presented in a friendlier format.
2) The ability to re-direct HTTP protocol requests to process different internet protocol requests such as FTP and SMTP
3) The ability for the domain owners to index their web contents as desired for the use in search engines.
4) The ability for domain owners to manage their internal and external web content URLs and present them as a part of their domain. Preferably, in a centralized controlled URL management service tools without having to make code changes.
5) The ability to setup massive numbers of CNAME(Alias) host records
6) On Twitter and some instant-messaging services, there is a limit on the total number of characters that can be used in a message. This limitation makes prevents long URLs from being used
7) Communicating or copying a URL that is hundreds of characters long can only really be successfully done by copy-and-paste since it is virtually impossible to memorize and remember. Trying to type one by hand will be time-consuming and result in errors.
8) Individuals and organizations communicate and exchange their phone numbers as a primary contact. Contact book software applications are used to store phone numbers on all devices including cellular phones and smart devices which are widely used for day-to-day tasks and are becoming an essential mean in getting a variety of tasks completed. An administrated service domain to map phone numbers to URLs for the purpose of easily accessing URLs from any device that is equipped with internet browsing capabilities, especially cellular phones and smart devices. The mapped URLs are established by the owner of the phone number of the organization or the individual. Where the owner is given the flexibility to associate related URLs for easy access by clients. For example: the user can setup the prefix map to point to the URL that is generated by maps.google.com and the client can easily access the URL by typing map.9991235566.urlisp.com or map.9991235566.wwext.com where “map” is the prefix, 9991235566 is the phone number of an individual or an organization, and wwext.com and wwext.com are the phone prefix service domains. The phone number service domain provides Application Programming Interfaces (APIs) as Web Services to allow existing and new contact information software applications to integrate to the service and provide a simple one click option to visit the URL Link(s) that are associated to the prefix “map” as well as other user defined prefixes. In addition, by using this service, contact software applications running on all devices will easily be able to add a one click “URL Links” option to visit all the URL links that are associated with any given phone number. This concept will save tremendous internet round trips between clients and servers and make the day-to-day tasks that require internet accessibility rather simplified.

The problems that currently exist are due to the existing rules that are defined by Domain Name Service (DNS) in setting up the A (Address) and CNAME (Alias) host records, these restrictions are:
1. There are no means to setup host records to point to fully qualified URLs. For example: http://Contact.MyBrandedName.com can not be setup to point to http://www.MyBrandedName.com/contact.aspx
2. There are no means to setup host records to point to a URL of an

FTP protocol type. For example, http://form1.MyBrandedName.com can not be setup to point to ftp://MyBrandedName.com/forms/form1.pdf
3. There are no means to setup a host record to point to an email link. For example, http://MyEmail.MyBrandedName.com can not be setup to point to mailto:myemail@MyBrandedName.com
4. There is no mean to define wild card CNAME (Alias) host records to resolve the dynamically generated web contents. For example: *.MyBrandedName.com to be setup to point to http://MyBrandedName.com/Search.aspx?p={*}, allowing the wild card value to be used for the following scenarios: http://test.MyBrandedName.com to be resolved as http://MyBrandedName.com/Search.aspx?p=test and http://another.test.MyBrandedName.com to be resolved as http://MyBrandedName.com/Search.aspx?p=another+test
5. According to year 2007 census there is an estimated 27,097,236 firms in the US alone. It is more likely that all these firms have at least one phone number. While Domain Name System (DNS) allows setting up CNAME (Alias) host records to point to qualified domain names in the form of subdomain.domain.tld. It is virtually impossible to setup 27 millions CNAME (Alias) host records, in the US alone, in the form of <Phone Number>.urlisp.com where each <Phone Number>CNAME (Alias) host record will be pointing to the an actual qualified domain.
6. The DNS specification of setting up CNAME (Alias) host records prohibits users from setting up the same record more than once. For example: it is not allowed to setup two (2) CNAME (Alias) host records with the same value “SEARCH” even if each record is pointing to a different qualified domain.

An attempt to address the existing problems has been proposed in U.S. Pat. No. 6,882,999 issued Apr. 19, 2005. The suggested solution does not demonstrate to be global and efficient due to the following disadvantages:
1. The solution suggests implementing an ISAPI (Internet Application Programming Interface) filter for use in conjunction with Microsoft's Internet Information Server as a remedy.
2. The suggested ISAPI needs to be implemented on every host server and it is not centralized so it can be consumed by all domains. Instead it suggests the implementation of the extension on every host server machine.
3. By having to implement the “extension” on every host machine, this approach will require additional programming in order to allow the owners of the domains being hosted on the server that implements the “extension” to manage their URLs. For example: if MyBrandedName.com is hosted on a server that implements the suggested “extension”. Additional programming, which may not be achieved, will need to take place before the owner of MyBrandedName.com can manage output URLs to setup the non-existent domain name sendmail.MyBrandedName.com to map to mailto:myemailaddress.MyBrandedName.com or ebay.MyBrandedName.com to map to the URL http://store.ebay.com/MyEbayStore. If no additional programming is performed on the host server implementing the suggested “extension”, the owner of MyBrandedName.com will need to constantly communicate with the host server's administration.
4. Since the suggested Web-site rendering engine is implemented as an “extension” for the use with Internet Information Server (IIS), a Microsoft product. Numerous host servers that do not use IIS will not benefit from it.
5. It does not provide a simple solution to all qualified domains (sub domains)
6. It does not provide the means for external host servers to resolve non-existent domains
7. It does not suggest tools for end-users of external or internal domains to map output URLs
8. The proposal does not provide a solution for mapping one value to multiple output URLs

Short link services such as tinyUrl.com and goo.gl allow the public to submit URLs and the host server will generate a short URL in the format of goo.gl/<generated value> or tinyurl.comkgenerated value> where the “generated value” is a unique value computed by the host domain service. While this solution is workable to some extent, it has the following disadvantages:
1. It obscures the target domain name from the output URL's final address. This is a major draw back for major organizations. For example: if amazon.com wants to shorten the above mentioned “Kindle->Kindle DX” URL, the generated URL may look like http://tinyUrl.com/XDNCGF which hides the amazon.com domain. It would be more advantageous and desirable to for Amazon to be able to easily map the long output URL that renders the web page http://wwvv.amazon.com/Kindle-Wireless-Reading-Display-Generation/dp/B002GYWHSQ/ref=sa_menu_kdx23 to http://www.KindleDx.amazon.com instead.
2. It is auto generated by the service and the user has no control in any part of the process other than providing the long URL
3. Once it is generated, there is no way to modify it and it is not maintainable by the requested user
4. It does not allow embedding any descriptive information within the link
5. The generated URL maybe short but still virtually impossible to remember
6. The lifetime of the short URL is controlled by the service that generates the short URL
7. Since the Target Domain Name is not a part of the URL, it will look suspicious when received by a client and the client will most likely not open it. For example: a client will feel more confident to access the URL http://www.KindleDx.amazon.com rather than http://tinyUrl.com/XDNCGF
8. Although this may be desired for legitimate business or personal reasons, it is open to abuse and for this reason; some URL shortening service providers have found themselves on spam blacklists, because of the use of their redirect services by sites trying to bypass those very same blacklists

### BRIEF SUMMARY OF EMBODIMENTS OF THE INVENTION

The present invention provides methods, services, and systems for handling non-existent domains that are produced by the wild DNS A (Address) host record that is setup for a qualified domain. The invention allows qualified domains to setup an A (Address) host record to point to a published IP address of a central host server that hosts a Qualified Domain Prefixes Processing Engine for re-directing HTTP Requests to a qualified output URLs, where a plurality of non-existent domains of qualified domains will be setup by types and defined in a friendly, short and easy to remember format to be re-directed to fully qualified internal or external complex and hard to remember output URLs. Embodiments of the invention provide for the ability to store the values of a plurality of non-existent domains and classify them by a set of prefix types, which are unique to each qualified domain, in a global database or a plurality of databases in the form of Domain Prefix (DMNPFX) records, providing ways to map a plurality of values and patterns to a specific or a plurality of output internet URL resources of the same or different protocol, the defined output URLs are also classified by a set of re-direct types and will also be stored in the database.

Embodiments of the invention also provide methods of setting up wild card Domain Prefixes (DMNPFX) allowing the recognition of prefixes of a specific pattern or non-matched pattern to be utilized in producing dynamic re-direct output URLs. The hosting server will remove the Domain Prefix (DMNPFX), the left-most part of the non-existent domain name, if the value can not be matched against a defined value or pattern in the database. In terms, the hosting server will re-direct the URL to a fully qualified registered domain as the output URL preventing the “HTTP 404 error: File not found” result from occurring. Embodiments of the present invention provide extended methods to retrieve the mapped URL re-direct output from an external storage system simplifying the steps for domains with large amount of Domain Prefixes (DMNPFX) that are already defined internally within a qualified domain's host server to be retrieved and used as the output re-direct URL by allowing registered domains to expose a plurality of output re-direct URLs as a result of consuming a web service. Settings of the web service address and its input parameters will be used by the host server's Qualified Domain Prefixes Processing Engine. Embodiments of the present invention provides methods to track the processed HTTP requests re-directs by storing the incoming HTTP Requests and their resolved output re-direct for analyses and administration requirements that might be needed by the registered qualified domains. Embodiments of the present invention also provides methods allowing a registered qualified domain to restrict other registered qualified domains from setting up defined prefixes with output re-direct URLs that re-direct to their qualified domain. In addition, embodiments of the present invention provide methods to identify all the prefixes of other registered domains that have setup and defined a plurality of prefixes with output re-direct URLs that are mapped to be re-directed to their domain.

Furthermore, embodiments of the present invention provides flexible methods to store uniquely identified entities such as phone numbers, in which a plurality of phone numbers that are globally unique by their country, area, and local number; can be used as the prefix of the service domain for the purpose of mapping them to a single or multiple fully qualified domains and internet resources output re-direct URL links and associating them to a plurality of searchable keywords. Individuals and organizations can register their phone number to be used as the prefix (PFX) of the service domain where the service domain will implement administrative methods and approaches to validate and authenticate the association of the phone number to the individual or the organization registering the phone number to ensure that the phone number truly belongs to the individual or the organization who is requesting to register a phone number. A phone number prefix (PFX) can also be mapped to a single qualified domain or a plurality of qualified domains of a registered individual or organization where further authentication will take place to verify the ownership relationship between qualified domains and a phone number.

In addition, embodiments of the present invention conveniently provide Application Programming Interfaces (APIs) methods utilizing plurality of prefixes that are identified as phone numbers and their associated output re-direct URLs to be used in new contact information system software applications and to be integrated in virtually all contact software applications that are currently used within a variety of devices such as desktops, smart devices, cellular phones, and navigation systems. Additionally, the domain service of phone number prefixes provides a “DOMAIN SERVICE JOIN TYPE” which enables other legitimate domains to service the re-direct output URLs of prefixes that are identified as the type of “phone number domain prefixes” and perform URL output re-direct to internet resources that are specific to the owner of the phone number for the purpose of communication between a registered service qualified domain and an owner of a phone number where the registered service qualified domain will be able to prepare and associate a specific internet resource to be rendered specifically for an owner of a phone number and is retrieved only by him/her. Mapping of phone numbers also provide security measures which are controlled by a registered owner of a phone number preventing the setup of “domain prefixes”, of a phone number type, to be mapped to an unwanted output re-direct URL. It also provides security measures where the associated URL output of a phone number is only revealed, processed and re-directed only when a registered owner of a phone number approves the output re-direct URL that is setup by a registered qualified domain. Further security methods are implemented to protect private output re-direct URLs that are associated to plurality of prefixes of a phone number type to be processed and re-directed to their mapped URL as recommended by a registered owner of a phone number.

Additionally, embodiments of the present invention provide simple administrated methods and approaches, identified as “DOMAIN TO DOMAIN JOIN TYPE” methods, allowing two registered qualified domains to process the same “domain prefixes” which in terms produce the same output re-direct URLs of the same or different protocol. It also provides flexible administrated methods and approaches identified as “DOMAIN PREFIX TO DOMAIN JOIN TYPE” allowing a “domain prefix” of a qualified domain to impersonate another registered qualified domain and allows the processing of all the “domain prefix” values appearing to the left-most part of a qualified domain and a “domain prefix” of another qualified domain to perform the same output re-direct URLs.

Another aspect of the present invention is directed to providing methods and systems to associate a plurality of defined domain prefixes to a plurality of keywords for use in an internet resource search engine and the use of this association for existing search engines, making it easy and flexible to a web site operator and a web site owner to setup a plurality of keywords for indexing static and dynamically generated internet resources such as web page contents or files residing on plurality of host servers. Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a presentation of a communication network which is suitable for use with one or more embodiments of the present invention

FIG. 2A is an illustration of the non-existent domain name and the designated label that is identified as the “DOMAIN PREFIX” (DMNPFX) of a qualified domain name in accordance with one or more embodiments of the present invention

FIG. 2B is an illustration of the non-existent domain name URL in accordance with one or more embodiments of the present invention

FIG. 2C is an illustration of the general form of a “DOMAIN PREFIX” in accordance with one or more embodiments of the invention

FIG. 3 is an illustration of distributed servers across multiple regions for use with one or more embodiments of the invention

FIG. 4 illustrates the setup of the web site on a host server processing the domain prefixes and the service domain of the phone number prefixes in accordance with one or more embodiments of the invention

FIG. 5A is a table which defines JOIN types in accordance with one or more embodiments of the invention

FIG. 5B is a table which defines PREFIX types in accordance with one or more embodiments of the invention

FIG. 5C is a table which defines OUTPUT URL types in accordance with one or more embodiments of the invention

FIG. 5D is a sample list of defined valued and patterned “Domain Prefix” records of a registered a qualified domain in accordance with one or more embodiments of the invention

FIG. 6 is a form for registering qualified domains requiring the handling and processing of the non-existent domain names in accordance with one or more embodiments of the invention

FIG. 7 is a registration form for individuals and organization requesting the handling and processing of their phone numbers with a service domain in accordance with one or more embodiments of the invention.

FIG. 8 is a flow diagram which describes the detailed logic of processing non-existent domain names, phone number prefixes for the purpose of locating specific resources in accordance to one or more embodiments of the invention

FIG. 9 is a flow diagram which describes the overall logic of the Abstract Setup Class of the Prefixes Processing Engine in accordance to one or more embodiments of the invention

FIG. 10 is a flow diagram which describes the overall logic of the Abstract Outbound Processing Class of the Prefixes Processing Engine in accordance to one or more embodiments of the invention

FIG. 11 is a form for setting up a re-direct prefix in accordance to one or more embodiments of the invention

FIG. 12 is a form for setting up a display prefix in accordance to one or more embodiments of the invention

FIG. 13 is a form for setting up phone prefix notification in accordance to one or more embodiments of the invention

FIG. 14 is a form of a registered phone or qualified domain for managing and setting up account information in accordance to one or more embodiments of the invention

FIG. 15 is an example of setting up phone prefix notifications to be displayed by a plurality of phone devices in accordance to one or more embodiments of the invention

FIG. 16 is an example of a phone numbers' mobile device displaying a received phone prefix notification using an enhanced contact software application in accordance to one or more embodiments of the invention

FIG. 17 is a search engine web page displaying results based on various searchable entities in accordance to one or more embodiments of the invention

FIG. 18A is an example of implementing the phone number service domain prefix to display phone URL Links in existing phone related applications in accordance to one or more embodiments of the invention

FIG. 18B is an example of implementing the phone number service domain prefix to be used as a keypad to dial phone URL Links in accordance to one or more embodiments of the invention

FIG. 18C is an example of implementing the phone number service domain prefix to enhance the missed call information in accordance to one or more embodiments of the invention

FIG. 19 is an example of a desktop contact application implementing the phone number service domain prefix APIs to obtain URL Links by phone number in accordance to one or more embodiments of the invention

FIG. 20 is an example of accessing phone URL links using a URL Links dial pad in a web application form in accordance to one or more embodiments of the invention

FIG. 21A is an example of an application implementing the domain prefix APIs to obtain URL Links which is installed on a mobile device in accordance to one or more embodiments of the invention

FIG. 21B is an example of a contact application implementing the phone number service domain prefix APIs to obtain URL Links by phone number in accordance to one or more embodiments of the invention

FIG. 22 is a block diagram of a computer that is suitable for connecting to and communicating over the internet in accordance to one or more embodiments of the invention

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

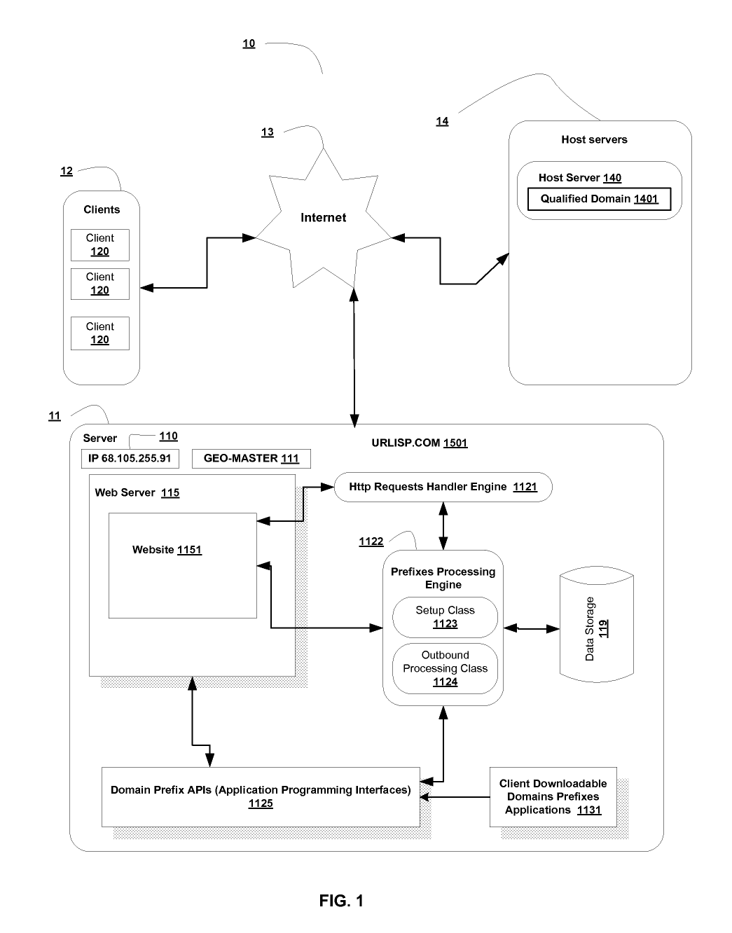

FIG. 1 represents a network 10 in accordance with the embodiments of the invention as presented. Network 10 consists of Clients 12, Servers 14 and server(s) 11 communicating over network 13.

In the described embodiment, Host Servers 14 consists of a plurality of host servers 140 connected to the internet. Clients 12 consists of a plurality of client 1201 connected to the internet. Host server 140 is connected to the internet and identified by a unique IP address. Host server 140 hosts the website of a qualified domain 1401, or multiple websites for a plurality of qualified domains 1401. The hosted qualified domain 1401 sets the wild card “*” A (Address) host record to point to the IP address of server 11, where all the non-existent domain names of qualified domain 1401 will be re-directed to defined output re-direct URLs after the qualified domain 1401 registers with server 11. In addition, individuals and organizations can use web site 1151 for the purpose of registering phone numbers to be processed as a prefix of the service domain urlisp.com 1503, which is a qualified domain that can be hosted on server 11 or a host server 140, with an existing wild card “*” A (Address) host record pointing to the IP address of server 11.

A central prefixes processing engine 1122 executes on server 11. Central prefixes processing engine 1122 consists of a Setup Class 1123 which processes and validates data and performs the storage of data into Data Storage 119 where the information about qualified domains, domain prefixes, phone numbers, and additional data is stored.

Data storage 119 is a relational database engine serving as the preferred method of storing data. Data is stored in the form of prefix records (PFX) a prefix record consists of the prefix value, prefix type, re-direct output URL, and the Output re-direct type. The combined total of prefix records is unlimited and the uniqueness of the prefix (PFX) records is established by the prefix value within each registered qualified domain and registered service domain prefix. This rule is enforced by Setup Class 1123.

Setup Class 1123 executes on server 11 and performs the following functional and procedural tasks:
1. Performs the appropriate operations of registering a Qualified domain with server 11.
2. Performs the appropriate operations of registering a Phone number prefix with server 11.
3. Performs the appropriate operations of associating a defined prefix to a single or plurality of output URLs
4. Performs the appropriate operations to validate the phone number to the registered user
5. Performs the appropriate operations to associate a phone number prefix that is defined in the phone prefix service domain to a qualified domain
6. Performs the required operation to associate a defined prefix to a plurality of searchable keywords
7. Performs the appropriate operations to secure an output URL or a plurality of output URLs of a domain prefix
8. Performs the appropriate operations to establish a “DOMAIN TO DOMAIN JOIN TYPE” between two registered qualified domains
9. Performs the appropriate operations to establish a “DOMAIN PREFIX TO DOMAIN JOIN TYPE” between a registered qualified domain and a prefix of a qualified domain
10. Performs the appropriate operations to verify that the qualified domain that is requesting to register with server 11 has setup the wild card “*” A (Address) host record to point to server 11 IP address 110.
11. Ensures that prefix values are unique to each registered qualified domain 1401 and domain service prefix

Prefixes processing engine 1122 represents the only means for accessing that data that is stored in the data storage 119 for the purpose of retrieving related output URLs that are associated to a given qualified domain 1401.

An outbound processing Class 1124 also executes as a part of the prefixes processing engine 1122. It performs all the necessary validation and operations to retrieve the output URL from data storage 119. Outbound Processing Class 1124 also performs the following functional and procedural tasks:
1. Perform the required operations to store and retrieve the associated output URLs of a domain prefix from the data storage 119 database
2. Perform the required operations to match the extracted domain prefix against the defined domain prefixes that are defined in the data storage 119 database

HTTP Requests Handler Engine 1121 executes on server 11 and is set as the HTTP Module of the default website 1151. HTTP Requests Handler Engine 1121 is implemented as a Class Library with the extension “.d11”. HTTP Requests Handler Engine 1121 performs the parsing of URLs that are received by server 11 to extract the qualified domain name 1401 and the domain prefix value which is the left-most label of a non-existent domain. The parsed information is sent to the Prefixes Processing Engine 1122 for the retrieval of the output URL(s) that is produced by the Outbound processing Class 1124. HTTP Requests Handler Engine 1121 returns the output URL(s) information to the HTTP Requests Handler Engine 1121 for the final re-direct URL to be returned by server 11.

Prefixes Processing Engine 1122 is implemented as a Class Library with the extension “.d11”. It contains the two main classes; Setup Class 1123 and the Outbound Processing Class 1124.

Website 1151 contains setup web form which allow a registered qualified domain 1401 to setup the desired handling of the non-existing domain names where domain prefixes, which can be associated to search keywords, can them be mapped to a single output URL or a plurality of output URLs of an HTTP protocol or different internet protocol.

Website 1151 contains web search engine web page(s) where users can search specific URL contents by a set of keywords, prefixes and variety of search options that are setup through Administration Web Forms which are also a part of website 1151.

Domain Prefixes APIs 1125 executes on server 11 and provide the necessarily interfaces for software vendors to process requests with input parameters defined by server 11. Domain Prefixes APIs 1125 exposes the majority of tasks that are performed by the Setup Class 1123 and the Outbound Processing Class 1124 that are used by website 1151. This exposure of APIs makes it flexible for software application vendors and website designers to integrate the various functionalities of the invention for use in their existing and new software and web applications.The use of Domain Prefixes APIs 1125 provide a great deal of flexibility for processing the same tasks that are performed by website 1151. The APIs are exposed in the form of the following web services:
1. http://www.urlisp.com/SetupServices.asmx
2. http://www.urlisp.com/OutboundProcessingServices.asmx

Each of the above web services will expose the necessary functional methods requiring and input object and will return a result object that can be parsed by clients. For example XML or JSON object.

Client downloadable domain prefixes applications 1131 reside on server 11 and are downloadable by client 140 for accessing domain prefixes mapped output re-direct URLs. Applications 1131 access output re-direct URLs through APIs 1125 executing on server 11.

Website 1151 also contains web pages that will be rendered by the web server 115 rendering engine when a domain prefix of a qualified domain 1401 is searched against the data storage 119 and the Output Processing Class 1124 matches a result of multiple mapped outputs re-direct URLs against a single Domain Prefix (DMNPFX). Generally, when using a web browser. For example: urls.sample.com when received by server 11 can be matched with a plurality of defined output re-direct URLs that were setup by the qualified domain sample.com. In this case, website rendering engine 115 will render a result page from website 1151 instead of performing a re-direct.

The GEO-MASTER 111 label is the geographical label of Server 11. This labeling allows for Server 11 to be replicated across multiple geographical regions where each server 11 will consist of the same components and will be identified with a different unique IP address 110 and a unique geographical label. This distribution of servers 11 will allow qualified domains 1401 to choose the IP address that is closer to their geographical region in the web form 1102 at the time of registration to process non-existent domain names

Components of FIG. 1 are shown to be on a single server 11, but it is realized that the integrated components of server 11 can and might be performed on several computers to perform the required tasks. For the purpose of illustration web server 150 FIG. 1 is an Internet Information Services (IIS), a Microsoft product. However, it is realized that the actual embodiment can utilize any other web server such as Apache and other popular web servers that are currently widely used.

As a preliminary matter, the discussion will use the following domain names and abbreviations below: “urlisp.com” 1501 is the domain name that is used and designated for the handling and the output re-directs URLs of qualified domains registration and their non-existent domain names.

Table-3 illustrates the use of the DNS Manager tool to setup the A (Address) host records of the domain dmnpfx.com

TABLE 3

| Entry # | Host | Points to IP address |
|---|---|---|
| 1 | @ | 68.105.255.91 |
| 2 | * | 68.105.255.91 |

“DMN” qualified domain name
“PFX” prefix value: the left-most part of the non-existent domain name
“PFXREC” Prefix record
“DMNPFX” domain prefix
“SVDMNPFX” service domain prefix
“WS” web service

### “PFXLVL” “PREFIX LEVEL”

### “PFXLVLVALUE”

### “PFXRESULT”

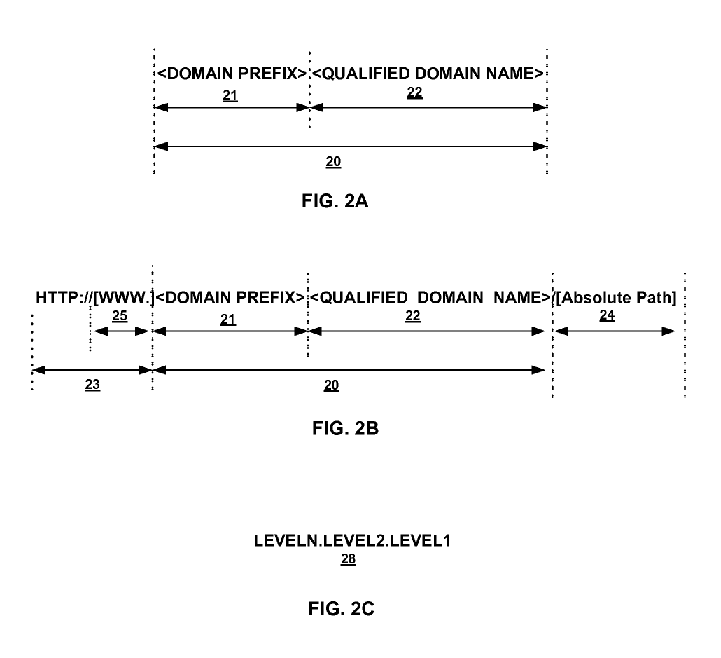

FIG. 2A is the format of the non-existent domain name 20 of a qualified domain name 22. “DOMAIN PREFIX” (DMNPFX) 21 is the left-most part the qualified domain name 22 separated by a dot “.”. The non-existent domain name 20 is a result of the qualified domain name 22 that has the wild card “*” A (Address) record present in the DNS zone file as mentioned in Table-1 Entry #4. For example sample.MyBrandedName.com is the non-existent domain 20 where the label sample is the Domain Prefix 21 of the qualified domain name MyBrandedName.com 22.

FIG. 2B illustrates the URL as is received by server 11 FIG. 1 in the form of an HTTP Request. Section 23 represents the HTTP scheme which can optionally include the “www.” label 25. When the “www.” label 25 is present the “DOMAIN PREFIX” (DMNPFX) 21 is identified as the value between the dot “.” that is present to the right of the “www.” label 25 and the dot that is present to the left of the qualified domain name 22 label. Label 22 ends with the forward slash “/” which separates the qualified domain name 22 from the requested resource 24. Label 24 is the absolute path of the location of the resource that is requested which is optional. The forward slash “/” will always be present in the URL and will be located to the right-side of the qualified domain name 22. Server 11 FIG. 1 ignores the <absolute path> 24 if it is present in a URL that is conformed of a non-existent domain name. For example: when the following URL; http://www.dmnpfx.sample.com/someResource.aspx, is received by server 11 FIG. 1. The absolute path 24, which in this example is “someResource.aspx”, is ignored by server 11 FIG. 1.

FIG. 2C is a representation of a “DOMAIN PREFIX” 21 levels. A “DOMAIN PREFIX” 21 can consist of multiple levels separated by a dot “.”.The right-most level is identified as level 1 and is incremented by one (1) as more dots “.” are present moving from right to left. The last level that is found is identified by level n where n is the total levels found in a give “DOMAIN PREFIX”. A registered phone number is considered a “PHONE DOMAIN PREFIX” and is a first level prefix of urlisp.com and can assign its own prefixes. For example: 6195551212.urlisp.com where 6195551212 is the first level prefix of urlisp.com and since it is a phone registration prefix, it will act as its own entity and can setup prefixes such as map.6195551212.urlisp.com where map is the first level prefix of 6195551212.urlisp.com

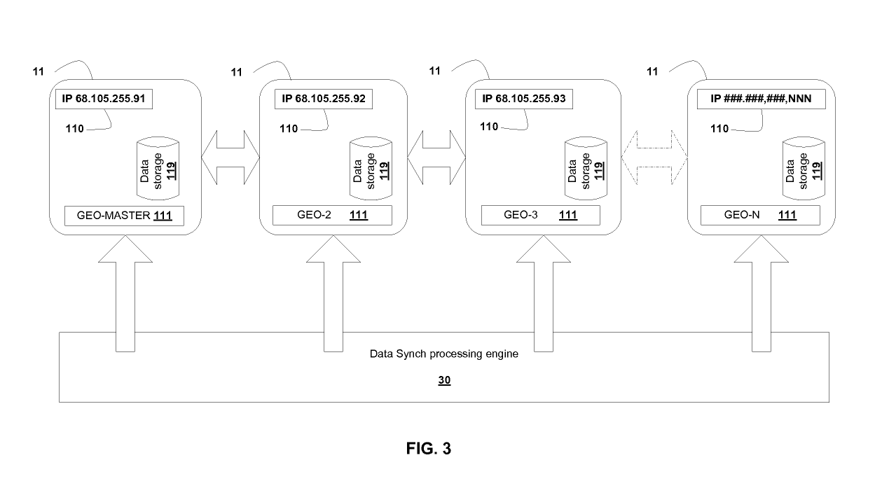

FIG. 3 illustrates the distribution of Server 11 FIG. 1 across multiple regions. Data Synch Processing Engine 30 executes on Server 11 FIG. 1 and performs all the necessary functionalities to replicate data across multiple servers 21 FIG. 1 for the purpose of synchronizing the data storage 119 FIG. 1 on each server 11 FIG. 1 of a different geo label 111 FIG. 1 and different IP address 110 FIG. 1.

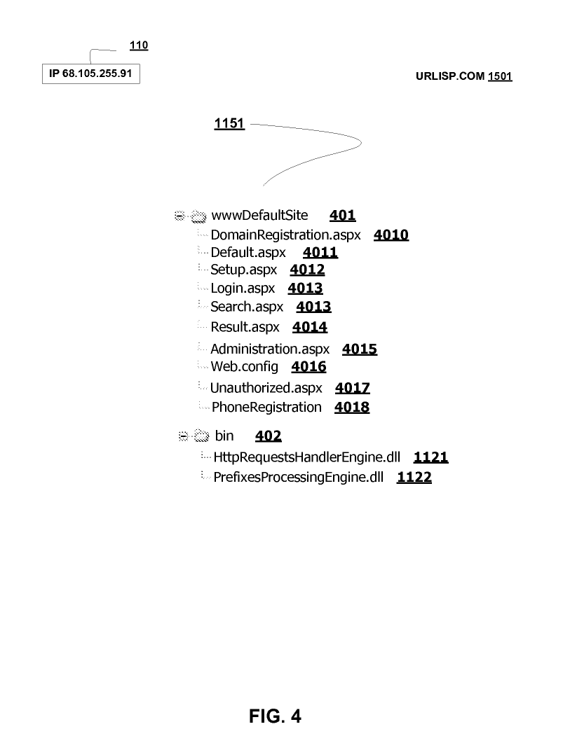

FIG. 4 is the detailed structure of the default website 1151 on server 11 FIG. 1

The root folder “wwwDefaultSite” 401 is the root folder for website 1151. Root folder 401 contains the default page 4011, a registration form 4010 enabling qualified domains and phone owners to register, a setup page 4012 allowing registered qualified domains and phone numbers' owners to setup prefixes and map them to output URLs, a login page 4013 for authenticating users, a search page 4013 for searching domain prefixes and keywords mapped to output URLs, and an Administration page 4015 for users to administer the various settings.

List page 4014 is the web page that will be rendered by the web server 115 FIG. 1 when a domain prefix (DMNPFX) is searched against the database 119 FIG. 1 and a plurality of output URLs are found. Page 4014 will display all associated URLs for the client to choose from.

The “bin” folder 402 is also a part of website 1151 FIG. 1 and it contains the class libraries HTTP Request Handler Engine 1121 which interfaces with the Prefixes Processing Engine 1122 Class Library

The web page 4017 is the unauthorized web page that will be rendered by web server 115 FIG. 1 when a non-existent domain name is received by server 11 FIG. 1 where the prefix value of the output re-direct URL is flagged for additional authentication or flagged as unapproved. For example: the non-existent domain mypicture.6195551212.urlisp.com is setup by the owner of the phone number 6195551212 where the second level prefix (PFX) mypicture is mapped to the output re-direct URL http://www.SomeDomain.com/pictures/MrCharles.jpg and the mapping is set by the owner to require a password instructing web server 115 to re-direct the request only if the client who is requesting the re-direct is able to provide the correct password which can be communicated by the owner of the non-existent domain mypicture.6195551212.urlisp.com to certain clients of her/his choice

The resource file web.config 4016 is essential to website 1151 FIG. 1. It contains all the required functional settings that are required by the rendering web server 115 FIG. 1 to process requests for website 1151 FIG. 1. A key setting in accordance to the described embodiment is the interface to the HTTP Request Handler Engine 1121 class library as it appears in the httpModule section of the web.config file 4016 as illustrated in the code snippet below:

```
<httpModules>
      <add name=“OutboundProcessingClass”
      type=“HttpRequestsHandlerEngine.
      OutboundProcessingClass, HttpRequestsHandlerEngine”/>
</httpModules>
```

The above setting instructs web server 115 FIG. 1 to intercept all HTTP Requests received by Server 11 FIG. 1. HTTP Request Handler Engine 1121 (FIG. 1) evaluates incoming URLs by executing methods made available in the outbound Processing Class 1124 FIG. 1 for determining whether Sever 11 FIG. 1 has received a URL that is a fully qualified URL to be rendered by web sever 115 FIG. 1 or if the URL is of a non-existent domain name of a qualified domain 1401 FIG. 1 that is registered with server 11 (FIG. 1) and has setup a wild card “*” A (Address) host record to point the server 11 (FIG. 1) IP address 110 (FIG. 1)

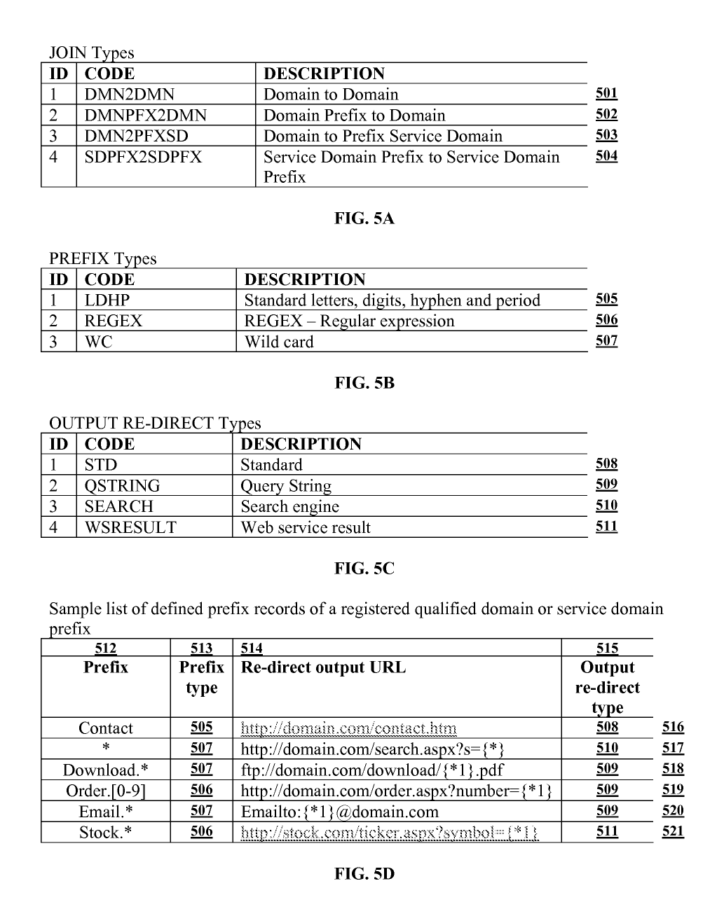

FIG. 5A is a list of JOIN types along with their codes as are interpreted by Setup Class 1123 FIG. 1 and Output Processing Class 1124 FIG. 1. The “Domain to Domain” join type 501 allows for a plurality of registered qualified domains 1401 FIG. 1 to share the same defined URL output re-direct in the case when a domain prefix of a non-existent domain name can not be matched against its domain but can be matched against a single or plurality of output re-direct URLs that are defined by the other joined domains. For example: the prefix “test” can be defined by the qualified domain “domain1.com: to re-direct to http://www.domain1.com/test.htm, “domain1.com” has an established “DMN2DMN” 501 join type with “domain2.com”, when the URL http://www.test.domain2.com or http://test.domain2.com is received by server 11 FIG. 1. HTTP Request Handler Engine 1121 FIG. 1 will re-direct the request to http://www.domain1.com/test.htm as defined by “domain1.com” if the prefix “test” can not be matched as a defined domain prefix of “domain2.com” and vise versa. If more than one “DMN2DMN” 501 join types are found to be established for “domain2.com” and multiple matching output re-direct URLs are found to match the prefix “test”; web page 4014 FIG. 4 will be rendered by web server 115 FIG. 1 to the client or the application initiating the Request. The use of this join type simplifies the process for organizations with multiple qualified domain names to easily share prefixes.

The “Domain Prefix to Domain” join type 502 allows for a prefix of one domain to impersonate a fully registered qualified domain 1401 FIG. 1 and process all the defined prefixes of the registered qualified domain. For example: a 502 DMNPFX2DMN join type can be set between the phone prefix 6195551212 of the qualified registered domain urlisp.com and the qualified domain MySite.com. When the URL http://6195551212.urlisp.com is received by server 11 FIG. 1, the HTTP Request Handler Engine 1121 FIG. 1 will re-direct the request to http://www.MySite.com. Similarly, if domain MySite.com has a defined prefix value “emailme” that is setup with the URL mailto:myEmail@myDomain.com. The HTTP Request Handler Engine 1121 FIG. 1 processing results will be the same for both URLs HTTP request http://emailme.6195551212.urlisp.com and http://emailme.mysite.com which in this case will execute the client's default email application with the email address myEmail@myDomain.com populated in the “TO:” address field. The use of join 502 DMNPFX2DMN makes it possible to associate uniquely identified identities such as the phone number to a plurality of internet resources.

The “Domain to Prefix Service Domain” join type 503 allows for a plurality of qualified registered domains 1401 FIG. 1 to join in servicing uniquely identified entities, the phone number in specific. Join 503 is an administrative join type providing trusted and qualified domains that are offering services where owners of the uniquely identified entities can chose to subscribe to. For example: maps.google.com, maps.yahoo.com, stores.ebay.com and so forth can join in the phone prefix service of the domain urlisp.com 1503. This use of join type 503 provides flexible and seamless way to easily handle phone numbers as prefixes of many existing service domains. A registered phone number 6195551212 will be able to access related information with service domains maps.google.com, yahoo.com, stores.ebay.com, facebook.com by simply prefixing the domain name with their phone number as: 6195551212.maps.google.com, 6195551212.stores.ebay.com, 6195551212.facebook.com. The advantages and powerful features of this join type will become more apparent as illustrated later in the described embodiment of the invention.

The “Service Domain Prefix to Service Domain Prefix” join type 504 allows for a plurality of registered Domain Prefixes of a service domain to share the same level 2 and higher defined prefixes to result in the same defined URL output re-direct. For example: the registered phone number 6195551212 with the phone service of the domain urlisp.com can be joined to 6195551313 where the second phone number is owned by the same or different owner allowing all the defined subsequent levels to be resolved to produce the same output re-direct results; such as http://directions.6195551212.urlisp.com and http://directions.6195551313urlisp.com. The use of this setting allows for a flexible way to associate multiple phone numbers that belongs to the same person or organization without having to setup the prefixes for each phone number.

FIG. 5B is a list of PREFIX types along with their codes, that are available for users at the time of setting up prefixes. They are also interpreted by Setup Class 1123 FIG. 1 and Output Processing Class 1124 FIG. 1 as procedural instructions at the time of processing requests. The “Standard letters, digits, hyphen and period” prefix type 505 indicates the prefix value is composed of letters, digits, hyphen and period only and is used for exact matching.

The “Regular Expression” prefix type 506 indicates a pattern matching prefix setup, to be matched if Output Processing Class 1124 FIG. 1 is unable to match a prefix type 505 against a domain prefix. An example of a REGEX prefix value setup may look like:

Order.[0-9].MyOrder.com and the re-direct output URL is http://www.MyOrder.com/Orderes.aspx?orderNumber={*1}
This pattern instructs Output Processing Class 1124 FIG. 1 to process alt the non-existent domain names of the qualified registered domain MyOrder.com that consist of a level 2 value of “Order” and a level 1 value that is a numeric value to be re-directed to the defined query string type output where replacement of level 1 value is to be used in the output URL as follow:
Order.123.myorder.com will be redirected to
http://www.MyOrder.com/Orderes.aspx?orderNumber=123
Order.5464.myorder.com will be redirected to
http://www.MyOrder.com/Orderes.aspx?orderNumber=5464 and so forth. However he following will not be evaluated in the same manner
Order.1a2x3.myorder.com will not be re-directed because level 1 contains non numeric values

The “Wild Card” prefix type 507 indicates a wild card matching prefix setup, to be matched if Output Processing Class 1124 FIG. 1 is unable to match a prefix type 506 against a domain prefix.

FIG. 5C is a list of “OUTPUT RE-DIRECT” types along with their codes, that are available for users at the time of setting associating output re-direct URLs to defined prefixes. They are also interpreted by Setup Class 1123 FIG. 1 and Output Processing Class 1124 FIG. 1 as procedural instructions at the time of processing requests.

The “Standard” output re-direct type 508 indicates that the output re-direct URL that is associated to a domain prefix, is of the “standard” type and requires no special handling. For example: qualified domain myDomain.com defines a standard prefix type 505 with the “test” value to be re-directed to the following “standard” output re-direct 508 type URL myOtherDomain.com/test.aspx.

The “Query String” output re-direct type 509 indicates that the output re-direct URL that is associated to a domain prefix, is of the “Query String” type and it does require special handling where the output re-direct URL will include special tokens of the format “{*n}” for the Output Processing Class 1124 FIG. 1 to replace with the prefix value accordingly. For example: qualified domain myAge.com defines a wild card prefix type 507 with the “*.*” value, which is a 2 levels wild card prefix, to be re-directed to the following “query string” output re-direct 509 type URL http://myAge.com/Defaultaspx?firstName={*2}&lastName={*1}

Output Processing Class 1124 FIG. 1 will redirect the non-existent domain name mike.smith.myAge.com to http://myAge.com/Default.aspx?firstName=mike&lastName=smith

The prefix mike.smith is a 2 levels prefix where “mike” is the second level and is used to replace the token {*2} as it appears in the above defined output re-direct URL and “smith” is the first level and is used to replace the {*1} in the above defined output re-direct URL.

The “Search Engine” output re-direct type 510 indicates that the output re-direct URL that is associated to a domain prefix, is of the “Search Engine” type and it does require special handling where the output re-direct URL will include a SINGLE {*} token for the Output Processing Class 1124 FIG. 1 to replaced with the prefix value accordingly. For example: qualified domain mySearch.com defines a wild card prefix type 507 with the “*” value to be re-directed to the following “search” output re-direct 510 type URL http://mySearch.com/Result.aspx?value={*}

Output Processing Class 1124 FIG. 1 will redirect the non-existent domain name blue.cars.mySearch.com to http://mySearch.com/Result.aspx?value=blue+cars

The “Web Service Result” output re-direct type 511 indicates that the output re-direct URL that is associated to a domain prefix, is of the “Web Service Result” type and it does require special handling where the output re-direct URL will not be entered by the user. Instead, the user will enter the web service information that needs to be consumed by the Output Processing Class 1124 FIG. 1 by means of passing the prefix value to the qualified domain web service and wait for the result to be computed and returned to the Output Processing Class 1124 FIG. 1 where further processing may take place before the output re-direct can be re-directed by sever 11 FIG. 1. This provides a great deal of flexibility to service domains when electing to join urlisp.com in servicing phone number prefixes. This become greatly appreciated since phone number owners who already have accounts with facebook.com, maps.google.com, maps.yaoo.com, stores.ebay.com can easily access their web contents by simply prefixing the major service domain name with their own phone number as follows:

6195551212.facebook.com will be re-directed to http://www.facebook.com/MyFaceBookPage
6195551212.stores.ebay.com will be re-directed to http://www.stores,ebay.com/MyEbayStorePage
6195551212.maps.google.com will be re-directed to http:/,% maps.google.com/maps?f=q&source=s_q&h1=en&geocode=&q=351+West+Univesity+Avenue,+San+Diego,+CA&aq=1&s11=37.0625,-95.677068&sspn=64.281297.111:269531&ie=UTF8&hq=&hnear=351+W+University+Ave,+San+Diego,+California+92103&z=17&iwloc=A

It should be apparent that the same will apply to all domains joining the urlisp.com service domain by the “Domain to Prefix Service Domain” join type and setting up a “wild card” prefix type that is mapped to a “Web Service Result” output re-direct type will become a flexible task to accomplish. Especially due to the fact that most service domains require users to supply a phone number and other contact information.

The combined values of the defined prefixes must be unique per each registered qualified domain 1401 FIG. 1. This rule is enforced and handled by Setup Class 1123 FIG. 1.

FIG. 5D is a sample list of Prefix records as stored in Data Storage 119 FIG. 1, which can be defined by a plurality of registered qualified domains 1401 FIG. 1 and registered domain service prefix.

In the described embodiment of the invention, Prefix (PFX) records consist of 4 fields:

Filed 1: [Prefix] presented as column 512
Field 2: [Prefix Type] presented as column 513
Field 3: [Re-direct output URL] presented as column 514
Field 4: [Output re-direct type], presented as column 515
Prefix records are independently associated to each registered domain (DMN) and “domain service prefix” (DSPFX). The value in column 512 is unique to each registered domain (DMN) and “domain service prefix” (SVDMNPFX) and can not be present more than once.

For the purpose of illustration, the presented list of Prefix records can be defined by the registered domain sample.com and a service domain prefix 6195551212.urlisp.com

When a URL is received by Server 11 (FIG. 1) as a non-existent domain name that resolves to any of the prefix values in column 512, Output Processing Class 1124 (FIG. 1) will redirect the non-existent domain names that match against the values in column 512 to the re-direct output URL as defined in column 514 according to its prefix type as defined in column 513 and its output re-direct type as defined in column 515 according to the rules that are illustrated the above section of FIG. 5C

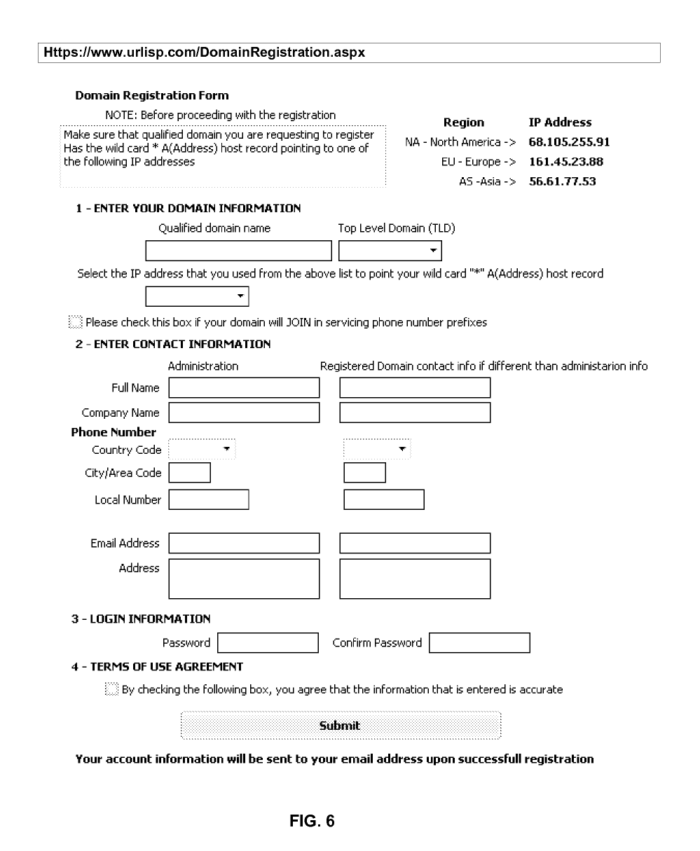

FIG. 6 is a registration web form that is rendered by web server 115 (FIG. 1) for qualified domains to register with server 11 (FIG. 1). In the described embodiment of the invention, Setup Class 1123 (FIG. 1) will use the collected and the submitted data to perform the validation and registration setup with data storage 119 (FIG. 1)

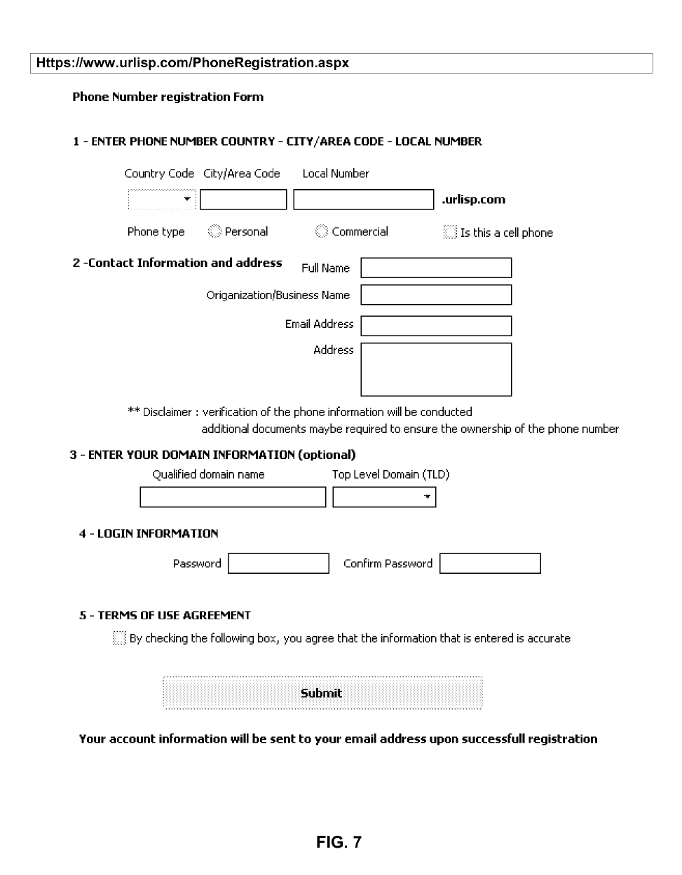

FIG. 7 is a registration web form that is rendered by web server 115 (FIG. 1) where owners of phone numbers can register phone numbers to be processed as “SVDMNPFX” of the phone service. In the described embodiment of the invention, Setup Class 1123 (FIG. 1) will use the collected and the submitted data to perform the validation and registration setup with data storage 119 (FIG. 1)

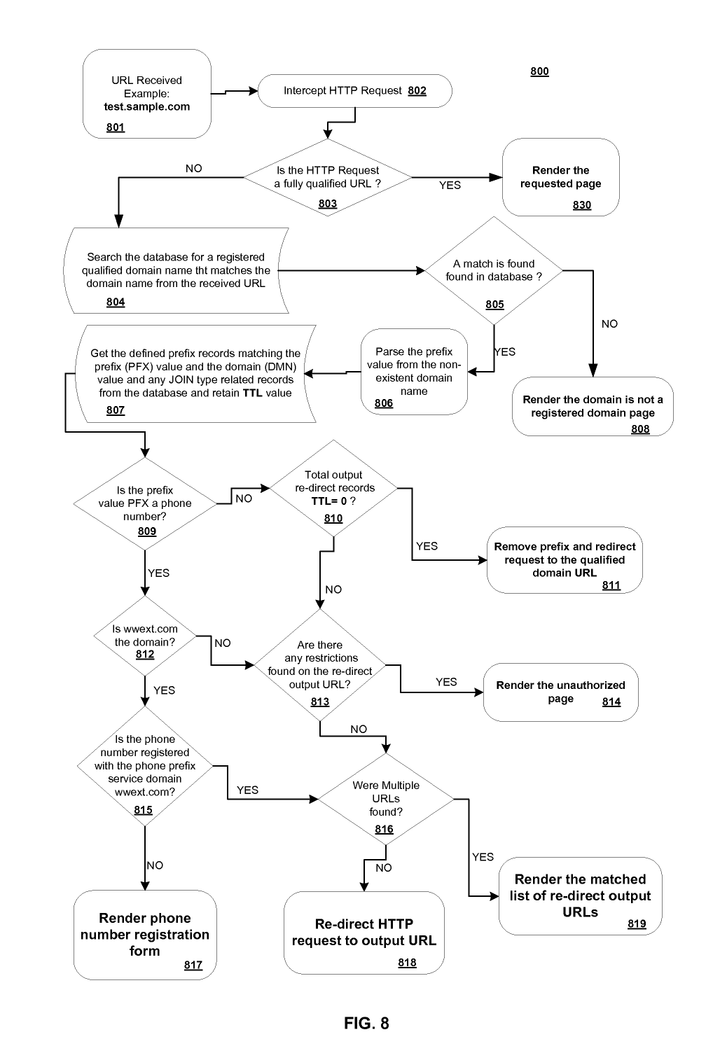

FIG. 8 illustrates a flow diagram describing the detailed logic of processing non-existent domain names and phone number prefixes for the purpose of locating specific resources in accordance with an embodiment of the invention. At 801 server 11 (FIG. 1) receives an input URL from client 120 or 140 (FIG. 1) in the form of an HTTP request which is intercepted at 802. The HTTP request is evaluated at 803 to determine if it is a fully qualified URL or a non-existent domain name. If it is determined to be a fully qualified URL, the process branches to 830 where the requested page will be rendered by web server 115 to client 120 or 140. If, at 803, the HTTP request is a non-existent domain name such as test.sample.com, the procedure branches to 804 where the server 11 (FIG. 1) registered qualified domains that are stored in the data storage 119 (FIG. 1) are searched against the non-existent domain name. At, 805, if no results are found in the database the procedure branches to 808 rendering “the domain is not a registered domain” page. This can occur if a qualified domain has a wild card “*” A (Address) host record pointing to server 11(FIG. 1) but did not register with server 11 (FIG. 1). At, 805, if a qualified domain is matched in the database, the execution proceeds to 806 where the prefix is parsed and the value, in this example “test”, is obtained. Execution proceeds to 807, where the defined prefixes of the domain “sample.com” along with the prefixes of and of its JOINED domains are obtained from database 119 (FIG. 1). The related re-direct output URLs are also obtained at 807 according to their associated output re-direct types and the total number of records found (TTL) is retained for later use in the process. Execution proceeds to 809 to determine if the value of the parsed prefix is a phone number. If, at 809, the value of the prefix is not a phone number, execution proceeds to 810 where the total value of the re-direct output URLs is examined. If, at 810, the total records is 0 (None) the procedure branches to 811 where the incoming request is re-directed to the qualified domain sample.com. If, at 810, the defined re-direct output URL records is greater than 0, the execution proceeds to 813 where the URL(s) are examined for any administrative restrictions. If, at 813, restrictions are found, the process branches to 814 where the unauthorized page is rendered to the client. If, at 813, no restrictions were found, the process branches to 816 to determine if the result consists of more than one record. If, at 816, the total number of URLs found is greater than 1 then the process branches to 819 where a web page with listing of the URLs found will be rendered by server 11 (FIG. 1). If, at 816, only one URL is found, then the process branches to 818 where the request is re-directed to the output URL. If, at 809, the prefix value is determined to be a phone number, execution proceeds to 812 to determine if the domain is the phone number service domain “urlisp.com”. If, at 812, the domain is found to be urlisp.com, the process branches to 815 where the phone number is searched against the database to determine if it is registered with urlisp.com. If, at 815, the prefix value of the type phone number was not found to be registered with domain urlisp.com, the process branches to 817 where the phone number prefix service registration page will be rendered to the client. If, at 815, the prefix value of the phone number type is found to be registered with urlisp.com, the process branches to 816 to determine if the result consists of more than one record. If, at 816, the total number of URLs found is greater than 1 then the process branches to 819 where a page listing the URLs found will be rendered by server 11 (FIG. 1). If, at 816, only one URL is found, then the process branches to 818 where the request is re-directed to the output URL. If, at 812, a prefix value of the phone number type is found but the domain is not urlisp.com, execution proceeds to 813. At 813, the process executes authentication and additional validation of the phone number to evaluate if any restrictions are present against the phone number when it is prefixed to a domain other than urlisp.com. If, at 813, restrictions are found, the process branches to 814 where the unauthorized page is rendered to the client. If, at 813, no restrictions were found, the process branches to 816 to determine if the result consists of more than one record. If, at 816, the total number of URLs found is greater than 1 then the process branches to 819 where a page listing the URLs found will be rendered by server 11 (FIG. 1). If, at 816, only one URL is found, then the process branches to 818 where the request is re-directed to the output URL.

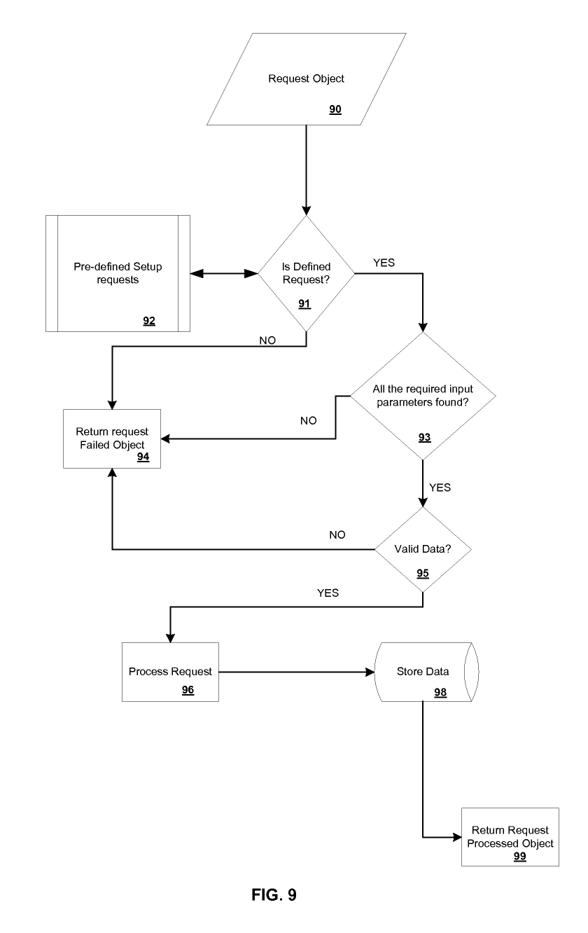

FIG. 9 illustrates the overall logic of the Abstract Setup Class of the Prefixes Processing Engine. Typically the request object 90 is compared at 91 against the list of pr-defined setup requests 92. Examples of defined requests are Add, Update and Delete registered URL links. If, at 91, the request is not defined the process branches to 94 and returns a fail object, typically of an XML or JSON format. If, at 91, the request is matched the process proceeds to 93 to evaluate that all input parameters are found. If, at 93, the required input are not found the process branches to 94 otherwise it proceeds to 95 to validate the data. If, at 95, the data is not valid the process branches to 94 otherwise it proceeds to 96 for execution then continue to 98 to save the request and finally returns and object at 99, typically of an XML or JSON format, for the client to parse as defined by server 11 (FIG. 1)

Samples of methods of the class are exposed by the Domain Prefix APIs 1125 (FIG. 1) as follows:

```
public object Add(object obj){
      //obj is the input object of a JSON type
      object result; // define the output object
      // program will process the input object
      return result; // return the output object
}
public object Update(object obj){
      //obj is the input object of a JSON type
      object result; // define the output object
      // program will process the input object
      return result; // return the output object
}
public object Delete(object obj){
      //obj is the input object of a JSON type
      object result; // define the output object
      // program will process the input object
      return result; // return the output object
}
```

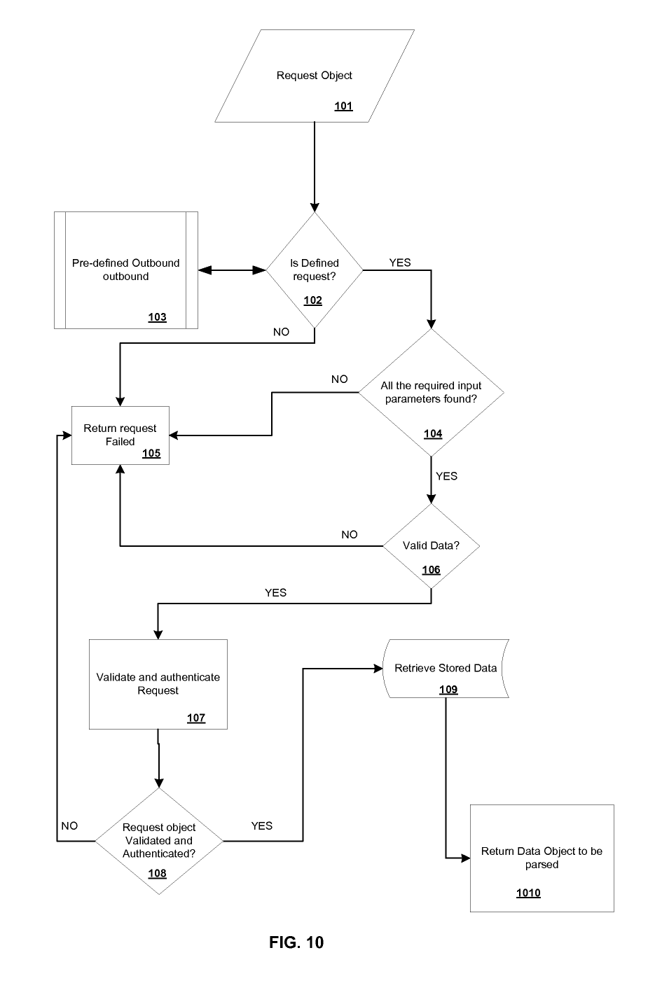

FIG. 10 illustrates the overall logic of the Abstract Outbound Processing Class of the Prefixes Processing Engine. Typically the request object 101 is compared at 102 against the list of pre-defined outbound requests 103. An example of a defined request is GetPhoneURLLinks. If, at 102, the request is not defined the process branches to 105 and returns a fail object, typically of an XML or JSON format. If, at 102, the request is matched, the process proceeds to 104 to evaluate that all input parameters are found. If, at 104, the required input are not found the process branches to 105 otherwise it proceeds to 106 to validate the data. If, at 106, the data is not valid the process branches to 105 otherwise it proceeds to 107 to further validate and authenticate the request. If, at 108, the request is not validated and authenticated, the process branches to 105 otherwise it proceeds to retrieve data at 109 and then return a data object 1010 for the client to parse. The returned object is typically of an XML or JSON format, for the client to parse as defined by server 11 (FIG. 1)

Samples of methods of the class are exposed by the Domain Prefix APIs 1125 (FIG. 1) as follow:

```
public object GetPhoneURLLinks(object obj){
      //obj is the input object of a JSON type
      object result; // define the output object
      // program will process the input object
      return result; // return the output object
}
```

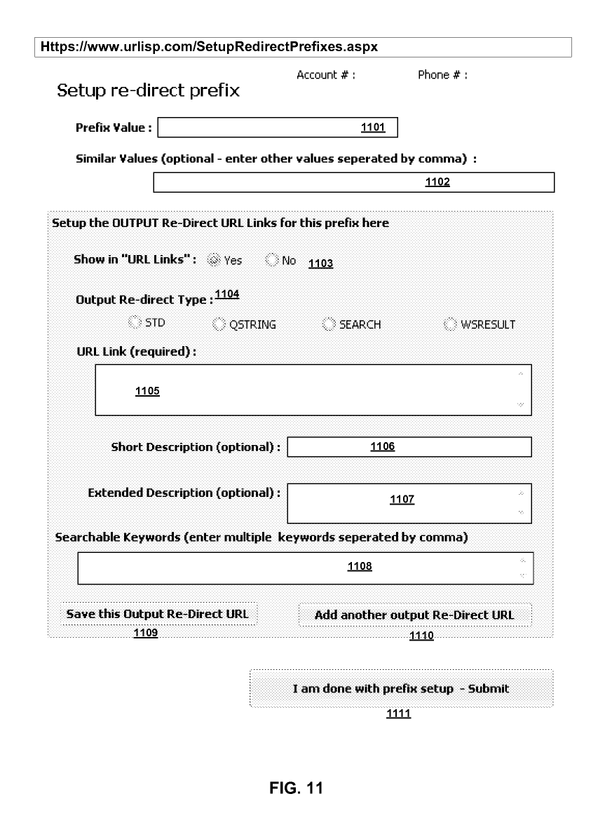

FIG. 11 is a form for setting up a re-direct prefix allowing a user to input a prefix value 1101 and associate similar values at 1102 where values entered at 1102 will create duplicate prefix records if not found to result in the same output re-direct by server 11 (FIG. 1). 1103 is an option for displaying the URL link to the public. The user chooses the output re-direct type at 1104 as illustrated in (FIG. 5C) and setup the URL link accordingly in 1105. The option 1106 is used to display the user defined label of the link and option 1107 is another additional display option. Searchable keywords 1108 are entered for search engine purposes and can be of an unlimited count and separated by a comma. Example: blue, red, black will instruct the search engine to retrieve this URL in the search engine. Entry is saved at 1109 once the button is clicked and the user is allowed to add multiple URLs at 1110. At 1111, the setup is considered complete by the user. The setup information combined is used as an API method for software applications to consume as well. It will be exposed as such:

```
public object SetupRedirectPrefix(object obj){
      //obj is the input object of a JSON type
      object result; // define the output object
      // program will process the input object
      return result; // return the output object
}
```

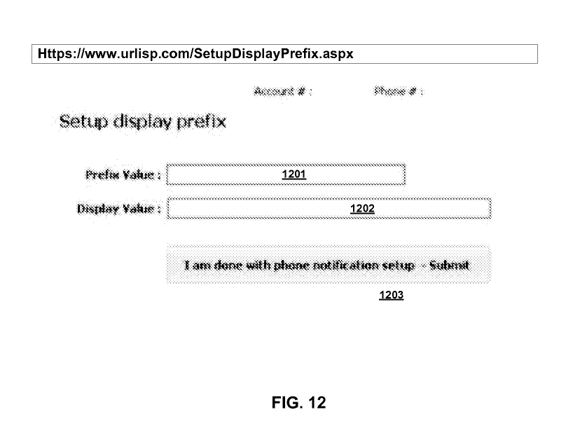

FIG. 12 is a form for setting up a display prefix at 1201 for the purpose of displaying the value entered at 1202. This setup instructs server 11 (FIG. 1) to use the prefix level for display purposes only. This flexible setup all setting up a director of prefixes where level 1 is a display and the higher levels are actual redirect URL Links. Example: mail.sample.com is a display prefix 1201 with the value “List of emails” 1202. The following re-direct prefixes Mike.email.sample.com and John.emal.sample.com will be considered a sub category of mail.sample.com. When the non-existent domain name mail.sample.com is received by server 11 (FIG. 1) Mike and John will be displayed in a sub menu style. The setup information combined is used as an API method for software applications to consume as well. It will be exposed as such:

```
public object SetupDisplayPrefix(object obj){
      //obj is the input object of a JSON type
      object result; // define the output object
      // program will process the input object
      return result; // return the output object
}
```

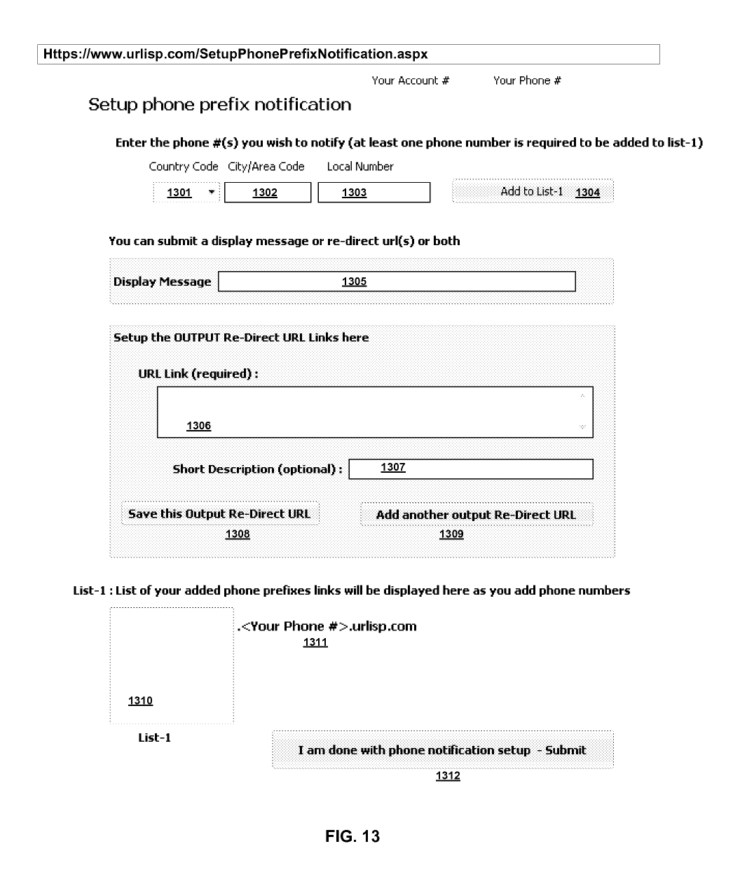

FIG. 13 is a form for setting up phone prefix notification for the purpose of generating a plurality of multi level domain prefix <Notify Phone>.<My Phone>.urlisp.com records to be accessed by recipients though a contact book that is installed on mobile device or a desktop. 1301, 1302, and 1303 are the country, area code, and the local number of a recipient and the user can add multiple recipients of a notification message that will be added to the list 1310. A phone prefix notification can be a display message (FIG. 12) or URL prefix (FIG. 11) or both. The phone prefix notification is complete at 1312. The setup information combined is used as an API method for software applications to consume as well. It will be exposed as such:

```
public object SetupPhonePrefixNotification (object obj){
      //obj is the input object of a JSON type
      object result; // define the output object
      // program will process the input object
      return result; // return the output object
}
```

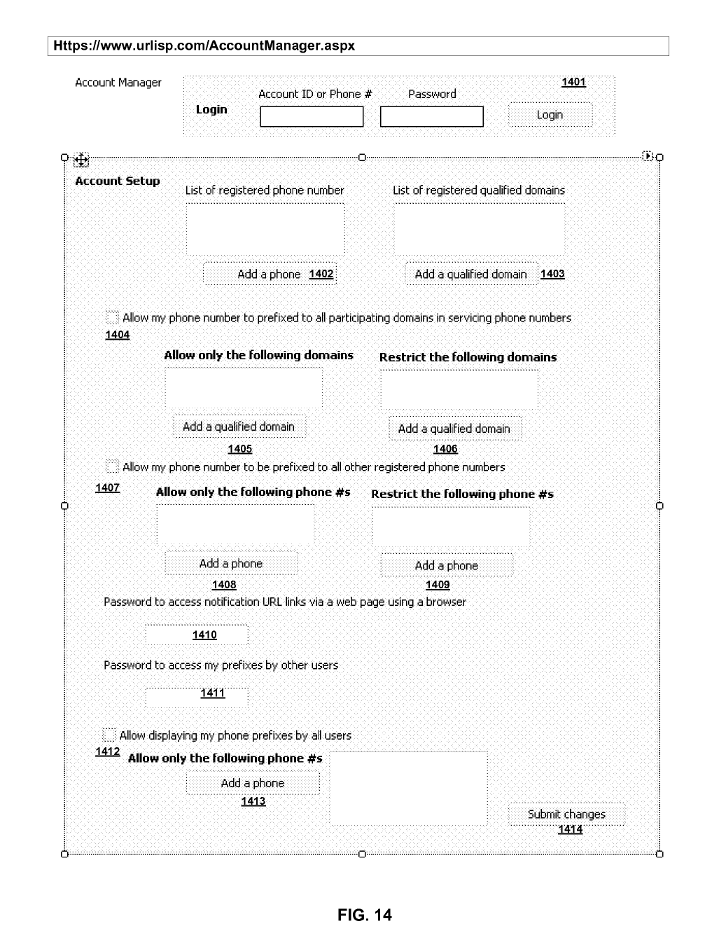

FIG. 14 is a form of a registered phone or qualified domain for managing and setting up account information at 1401 authentication is performed. At 1402 additional phone numbers are added. At 1403 additional qualified domains are added. At 1404 the user can check box to allow his/her phone number to be prefixed to all domains servicing phone numbers or allow only those that are present in 1405 or all but not the ones present in 1406. At 1407 the user can check box to allow his/her phone number to be prefixed to all registered phone numbers or allow only those that are present in 1408 or all but not the ones present in 1409. At 1410 the user setup the password to open non-existent domain names with his/her phone number used as a prefix when using a browser. At 1411 is the password required for other people to view the content of the URL link. At 1412 the user checks the box to all his/her prefix re-direct record to be displayed by all other registered phone numbers or only those that are listed at 1413. The changes are saved at 1414. The setup information combined is used as an API method for software applications to consume as well. It will be exposed as such:

```
public object SetupAccount (object obj){
      //obj is the input object of a JSON type
      object result; // define the output object
      // program will process the input object
      return result; // return the output object
}
```

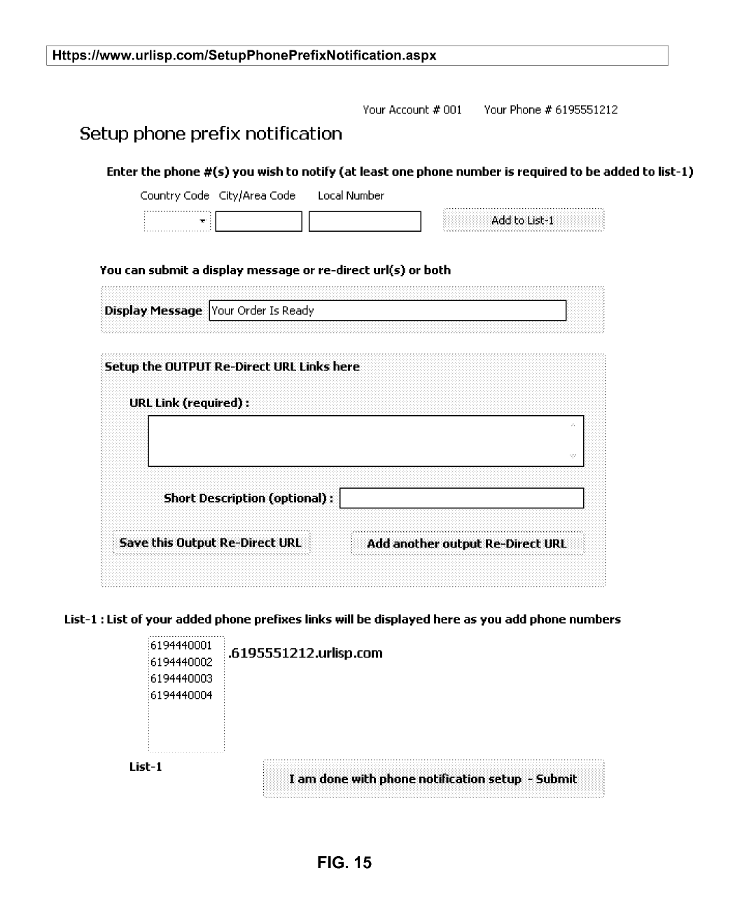

FIG. 15 is an example where the registered user of the phone 6195551212, who is the owner of a restaurant with the domain MyRestaurant.com, has setup the phone prefix notifications message “Your order is ready” FIG. 13 to four different customers' phone recipients 6194440001, 6194440002, 6194440003 and 6194440004 to inform them that their order is ready.

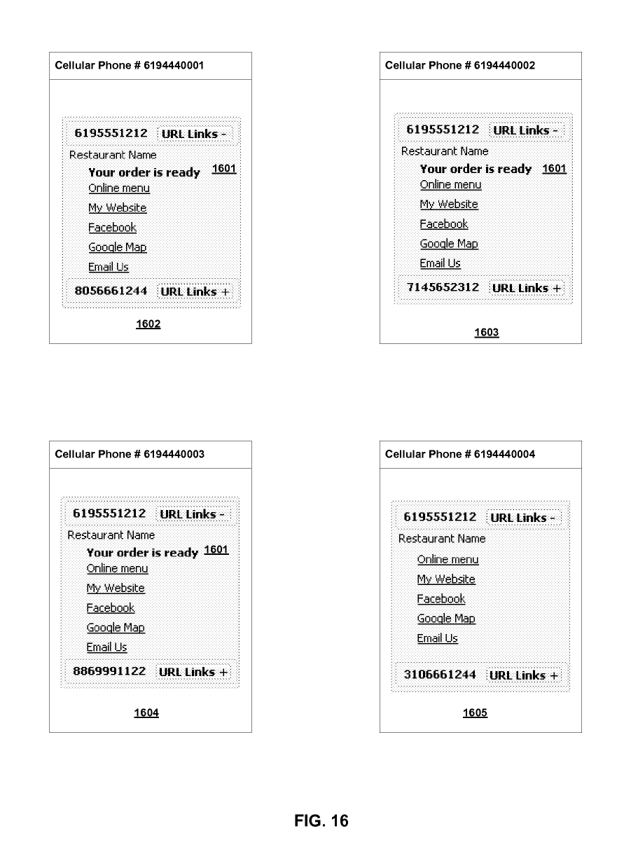

FIG. 16 illustrates how the recipients 1602, 1603 and 1604 in (FIG. 15) can view the message 1601 on their cellular phone using an enhanced contact software application where the phone number 6195551212 has been added to the contact book. Cellular 1605 did not display the message because the registered phone number 6194440004 did not check 1412 (FIG. 14) nor was phone number 619555121 added to 1413 (FIG. 14). The same result can also be displayed to each phone owner by typing the URL or 6194440001.6195551212.urlisp.com or 6194440002.6195551212.urlisp.com or 6194440003.6195551212.urlisp.com and finally 6194440004.6195551212.urlisp.com, typically in a browser where the each user will be prompted to enter the password.

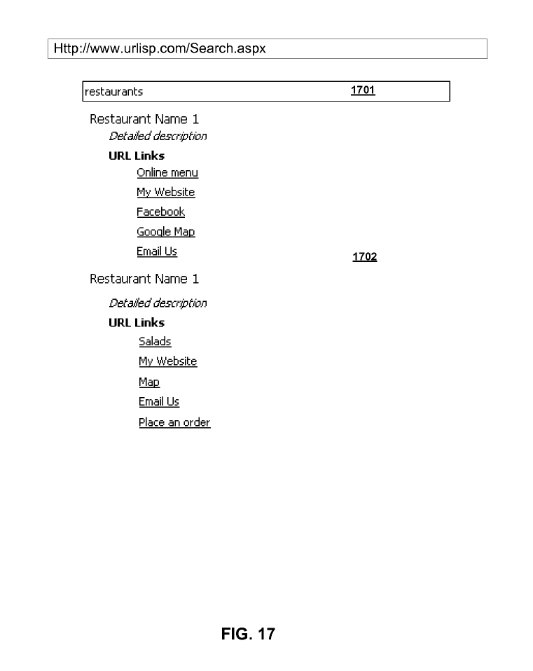

FIG. 17 is a search engine web page displaying results based on various searchable entities as the user enter a keyword at 1701 and hit the enter key. The computed result 1702 is produced based on the keywords search in the data storage 119 (FIG. 1) for each user defining prefixes and associating keywords as illustrated in FIG. 12

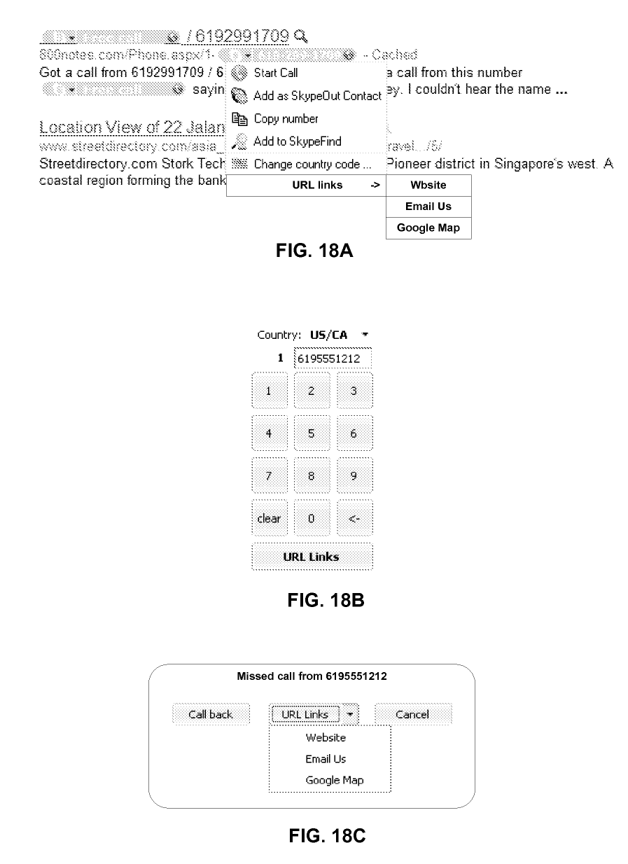

FIG. 18A demonstrates, as an example, the popular Skype software consuming the GetPhoneURLLinks(object obj) method that is exposed by the Domain Prefix APIs 1125 (FIG. 1) to provide show “URL Links” functionalities

FIG. 18B demonstrates, as an example, a keypad to dial phone URL Links by consuming the GetPhoneURLLinks(object obj) method that is exposed by the Domain Prefix APIs 1125 (FIG. 1) to provide show “URL Links” functionalities

FIG. 18C demonstrates, as an example, enhancing the popular missed call screen that is displayed on mobile devices by consuming the GetPhoneURLLinks(object obj) method that is exposed by the Domain Prefix APIs 1125 (FIG. 1) to provide show “URL Links” functionalities

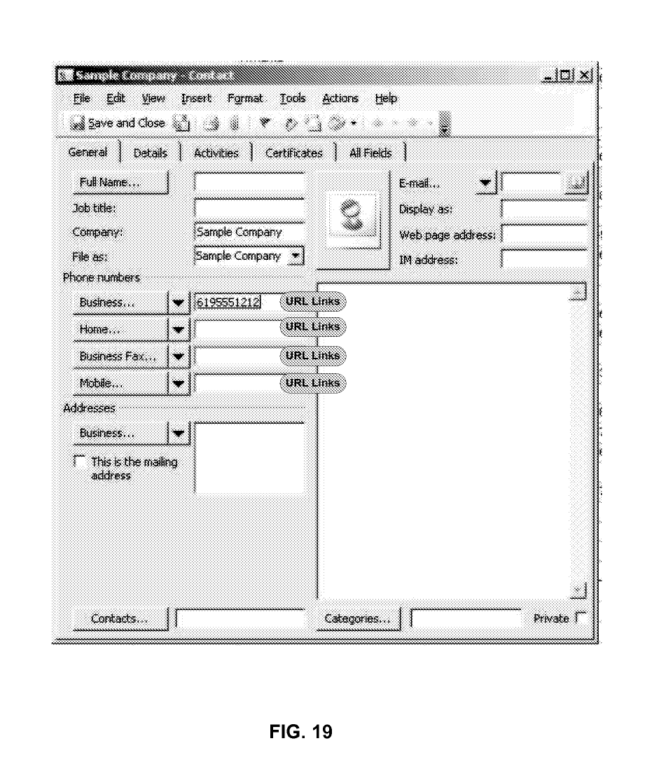

FIG. 19 demonstrates, as an example, a popular desktop contact book by consuming the GetPhoneURLLinks(object obj) method that is exposed by the Domain Prefix APIs 1125 (FIG. 1) to provide show “URL Links” functionalities

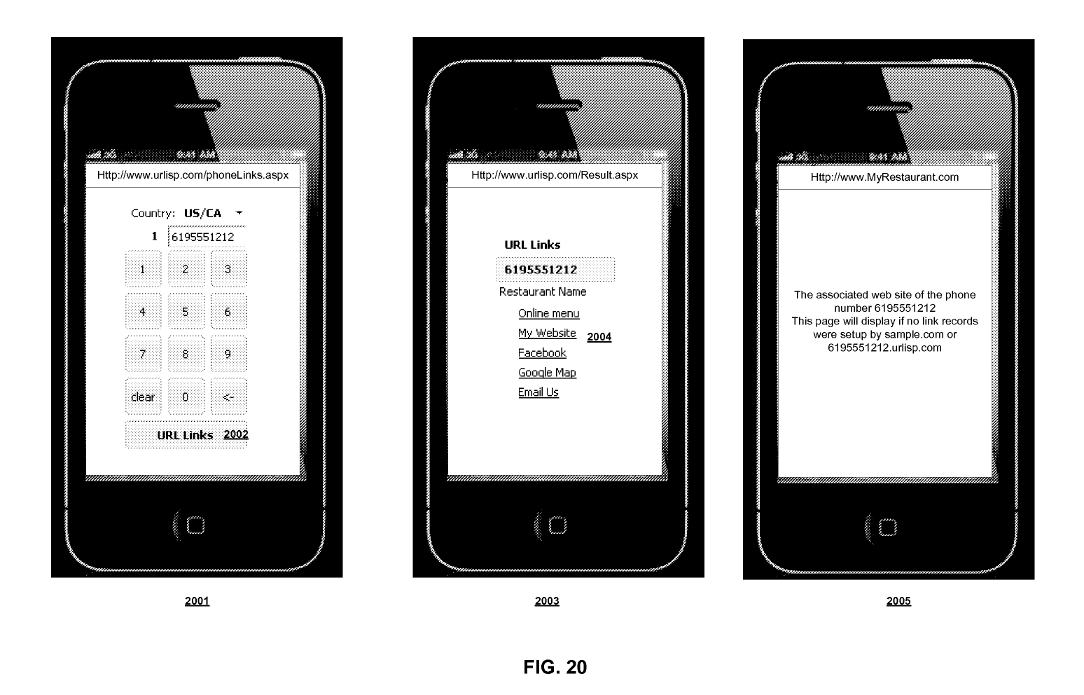

FIG. 20 illustrates accessing URL links using a URL Links dial pad by consuming the GetPhoneURLLinks(object obj) method that is exposed by the Domain Prefix APIs 1125 (FIG. 1) in a web application form 2001 and clicking the button 2002 where a plurality of links, if found, will be displayed in 2003 and a single page will be displayed at 2005 if no prefixes were defined by 619555121 or the user click on the link 2004 defined by user 6195551212

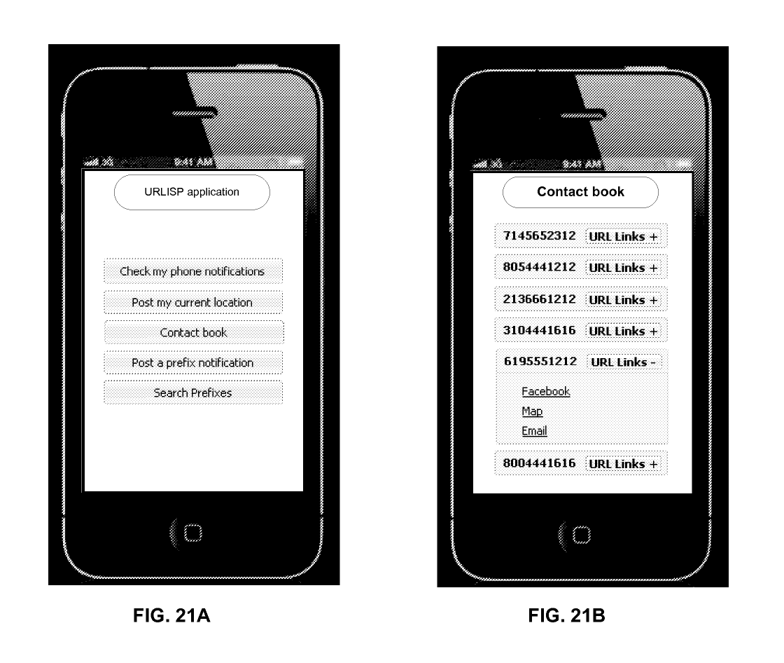

FIG. 21A illustrates an application installed on a mobile device consuming methods that are exposed by the Domain Prefix APIs 1125 (FIG. 1) along with customized methods provided by the device's APIs to perform additional advanced tasks.

FIG. 21B illustrates a contact book application installed on a mobile device consuming methods that are exposed by the Domain Prefix APIs 1125 (FIG. 1). The contact book application illustrates how all phone numbers can become a key and rather very useful unique entity in accessing specific URLs pertaining to a domain through the use of the Phone Number that can also be JOINED to a qualified domain name

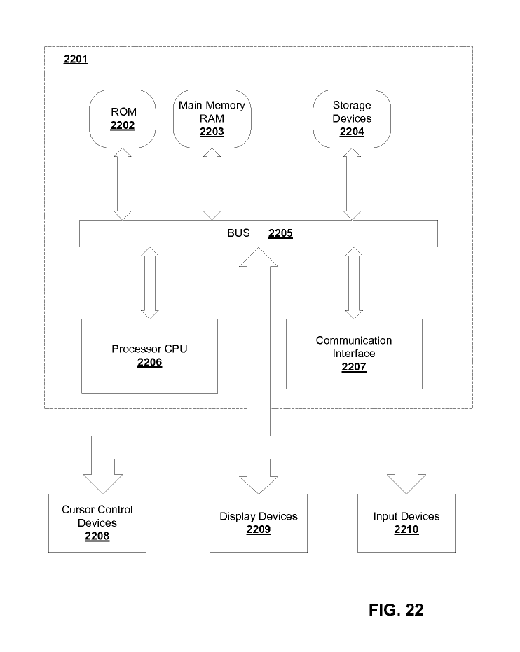

FIG. 22 is a block diagram of a computer that is suitable for connecting to and communicating over the internet as server 11 (FIG. 1), client 120 (FIG. 1) and server 140 (FIG. 1)

It is advantageous to be able to access specific resources for the following reasons: 1) An organization can spend a fortune on building and designing a website which includes navigation features such as menus and embedded links to navigate among pages. A website can consist of server drilled down levels that lead to specific information. After launching a website to the public, a website owner has no easy and friendly mean to communicate about the location of the drilled down resources. The owner of a website is left with few options to communicate about drilled resources within the website, few of which are:
1. Walk someone though the build in navigation with in the site to reach to the final destination
2. Get to the final destination him/her self and dictate the URL to another person, which is more likely going to lead into errors, or copy and paste the URL and mail it to someone.
3. Contact the web master who designed his site and maybe provide a link page where the desired list will still need to be maintained by the webmaster, this option will lead into incurred cost and will not be very effective.

2) Trying to group several resources that relate to a specific point that might be related to a certain business transaction or topic of interest within a website is also not possible. In general, once the website is published the task of accessing specific resources in the form of URLs is a difficult and cumbersome task.

3) A website owner can sign up with dmnpfx.com and setup the wild card address to point to the invented server where this task can be easily handled and additional features can also be accomplished

Urlisp.com allows one to group and sub-group URLs in the form of non-existent domains. With this feature, one can index the website in many flexible ways making the task of communicating about specific resources extremely simple without requiring additional attention by the webmaster. Additionally, one can setup external URLs that are related and associated to the service provided by business through other websites. For example: a toy store owner can have an established website “toystore.com” which is made of several pages listing all the products, contacts, links and other pages that relate to the business. Later on the owner posts a video on how to assemble a certain toy to the popular domain youtube.com. The URL to the video can take on the form of youtube.com/somevideolink. Currently, the owner of the toy store will have to communicate the URL to his/her clients and ask the webmaster to embed the link into one of the pages of his/her website. Both resolutions will need to be communicated to clients in a rather difficult and lengthy fashion. The invention will allow the owner of the domain toystore.com to setup a YouTube prefix pointing to the URL that is assigned by youtube.com. The owner can simply communicate about the link in the form of youtube.toystore.com and the invented server will re-direct the request to youtube.com/somevideolink. Moreover, the owner of the toystore.com domain can publish several videos to youtube.com each of with will have its own hard to remember URL. The invention provides the owner a mean to associate the prefix YouTube to multiple URLs each of which can have a friendly label. The list can be presented to the client to choose from in the form of youtube.toystore.com and because the prefix YouTube is mapped to multiple URLs, the list will be presented on a list page for the user to select from. Each link on the list will be presented by the short and friendly description that was assigned by the owner. Further more, each link can be presented in its own level 2 prefix such as v1.youtube.toystore.com, v2.youtube.toystore.com and so on. One can clearly appreciate the flexibility of the approach. As described by one embodiment of the invention, toystore.com can associated the company's phone number 8001254242 to the domain when registering the phone number with phone number prefix service of domain urlisp.com making it possible to access the same resources by typing youtube.8001254242.urlisp.com and the YouTube links of the toy store to appear in virtually all contact books. The same steps can be used to setup prefixes to re-direct to web pages that are related to the toystore.com domain; internally within the same domain and externally with any other domain the owner is using to promote services and products. Another gratefully appreciated prefix would be a map prefix where the map URL of the business will be rendered by the invention server to a client by simply typing map.toystore.com or by typing map.8001254242.urlisp.com where the later non-existent domain can easily be displayed and accessed on a mobile device as a child item off the contact book that already exists on the cellular phone or any other client device with any type of contact book software application. By establishing a join between the domain and the phone number, accessing internet resources can be simplified on mobile devices especially with the ability to be able to prefix the phone number with friendly values that are mapped to complex and hard to remember URLs. An added advantage is the fact that establishing a join between the domain and the phone number allows using the same prefixes whether they were setup as a prefix of the phone number or the domain seamlessly making Internet resources of individuals and organizations as simple as a missed call where devices can convert a received or missed call to aid in finding its related internet resources in the form of <phone number>.urlisp.com

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A URL service system providing domains configured for utilizing non-existent domain names resulting by the wild card “*” setting of the A (Address) host record for the purpose of using the left-most value of the non-existent domain name to search a plurality of values that are stored in a central database and are mapped to a plurality of defined output re-direct URL links, the URL service system comprising:
a central database for storing registered qualified domains;
a central database for registering and storing phone numbers for the purpose of having them prefixed to qualified domains and non-existent domain names for the purpose of communication and establishing communication and linking channels;
a centralized host server exposing its IP address for other domains to use as the host IP address to point to when setting up their wild card “*” A (Address) record;
a service domain to handle and process phone numbers for the purpose of associating a phone number to a qualified domain and locating related internet URL information, wherein the general format is: phone number.urlisp.com.

2. A method of prefixing qualified domains to retrieve specific internal and external URL internet resources as defined by the qualified domain operators, comprising:
storing a plurality of prefixes and associated keywords defined by users in a centralized database; and
searching the internet for the prefix values to locate specific internet resources.

3. The method of claim 2, wherein the prefix values are telephone numbers.

4. The method of claim 2, further comprising:
receiving and accepting a request from a service domain to join in servicing the phone number prefix by introducing a SERVICE JOIN Type.

5. The method of claim 4, further comprising extending contact software applications to display internet URL resources by consuming a plurality of defined Application Programming Interface methods that are associated with handling a processing procedures which are associated with the handling of non-existent domain names.

6. The method of claim 5, wherein the non-existent domain names comprise a phone number value.

7. A method of prefixing qualified domains to retrieve specific internal and external URL internet resources as defined by the qualified domain operators, comprising:
receiving an HTTP request URL having a qualified domain and at least one domain prefix;
determining whether the HTTP request contains a fully qualified URL;
if the HTTP request does not contain a fully qualified URL, then searching a database of for a qualified domain name that matches the qualified domain name in the received URL;
if a match is found in the database, determining the value of the domain prefix;
retrieving records associated with the domain prefix, wherein the records contain a second URL;
rendering the second URL.

8. The method of prefixing qualified domains of claim 7, further comprising determining whether the prefix value is a phone number.

9. The method of prefixing qualified domains of claim 8, wherein if the prefix value is a phone number, determining whether the phone number has been authorized via an approval process.

10. The method of prefixing qualified domains of claim 7, wherein the records associated with a domain prefix comprise a plurality of second URLs
